(19) United States
(12) Patent Application Publication
(10) Pub. No.: US 2011/0213644 A1
(43) Pub. Date: Sep. 1, 2011

(54) Consumer goods price prediction and optimization

(76) Inventor: Kaustubha Phene, Lexington, MA (US)

(21) Appl. No.: 12/927,043

(22) Filed: Nov. 5, 2010

Related U.S. Application Data
(63) Continuation-in-part of application No. PCT/US2009/002788, filed on May 5, 2009.
(60) Provisional application No. 61/050,325, filed on May 5, 2008.

(51) Int. Cl. G06Q 10/00; G06Q 30/00

(52) U.S. Cl. 705/14.1; 705/1.1

(57) ABSTRACT

A processing apparatus transforms storage elements to receive historical and competitive price information and predict effective pricing levels for retail goods and transform output media to allow effective decision-making and product pricing.

The present invention is a Continuation-in-Part of PCT Application number PCT/US2009/002788 having an international filing date of May 5, 2009, the disclosure of which is herewith incorporated by reference in its entirety, which in turn claims priority to U.S. provisional patent application No. 61/050,325 filed on May 5, 2008 the disclosures of which are herewith incorporated by reference in their entireties.

### FIELD OF THE INVENTION

The invention described here relates to systems, methods and apparatus for merchandising of retail goods, and more specifically systems, methods and apparatus for the merchandising of retail goods at advantageous pricing.

### BACKGROUND

The pricing of goods at retail was historically conducted on an intuitive basis by merchants responsible for a particular outlet. A merchant would apply his anecdotal knowledge of local supply and competitive pricing conditions to decide what price to charge for a particular good or class of goods. A retailer with superior intuition would likely be successful while another with an inferior intuition would often go out of business. From a societal perspective this may have been efficient, but from the perspective of the individual retailer (particularly the one with less successful intuition) this could be a very unpleasant system.

With the expansion of industrial production and complex supply chains, retail outlets emerge with large numbers of items and complex pricing demands. Various parties have attempted to apply, for example, computerized models to ascertaining appropriate pricing for particular items in such a commercial environment based on historical sales information and other factors. The effectiveness of such models has been limited, and many parties have been involved, with limited success, in attempts to develop more effective pricing models.

Without intending to acknowledge any priority of invention, it is noted that various models related to price optimization are discussed in the US patent application publication number 2005/0096963 to Myr, et al. as published on May 5, 2005, and also in the various references cited in that publication, all of which are herewith incorporated by reference in their entirety.

### SUMMARY

Having examined and understood a range of previously available devices, the inventor of the present invention has developed a new and important understanding of the problems associated with the prior art and, out of this novel understanding, have developed new and useful solutions and improved devices, including systems methods and apparatus yielding surprising and beneficial results.

Though for decades retailers have invested significant resources in understanding consumer demographics and competitive profiles, they have not created highly integrated processes and automated systems which on the one hand relate the results of the analysis of consumer demographics, characteristics of a geographical area such as quality of transportation, consumer drive times, weather conditions on an on-going basis to the operational systems of pricing, product assortment, in-store merchandising practices and marketing. Also, the consumer demographic profile and competition's profile is different in each trade area. Retailers do not have automated systems which recognize the differences and recommend most optimal price and assortment recommendations. Thirdly, consumer demographics, drive times, and competition profile are not static. Competitors open, close, remodel stores. The retailers themselves open, close and remodel their own stores. New roads come up and change the drive time equations. Both the retailer and competitors change their in-store merchandising practices and pricing philosophies. Currently there are no systems which capture and recognize such changes in an organized and comprehensive manner, analyze their collective impact and adjust the prices, product assortment, in-store merchandising practices and marketing strategies to achieve the most optimal results.

Retailers have always known that a consumer's decision to select a store depends on many factors including product selection, price, drive time, quality of customer service, wait time at the check-out lane, cleanliness etc. They spend considerable resources in doing market/focus group surveys to understand consumer perceptions of their and competitor's stores. In a disjointed effort, retailers also spend considerable resources to understand competitor's prices. They also use fairly informal methods to understand competitor's product assortments etc. They undertake separate efforts to analyze competitor's advertisements. But they don't have systems which look at these factors in a comprehensive manner and which provide a rational understanding of why their market share is what it is and, more importantly, to improve the market share which factors they need to change, by how much and what's the most optimal course of action. The present invention (Presto) is the first system to do that.

Retailers have always known that store location is extremely important and drive time to the store plays a very important role in a consumer's decision to visit/not to visit a store. But they have not really attempted to convert the drive time into a monetary visit cost and looked at the visit cost as an overhead to the cost of purchases at the store. Also, when retailers compare their prices with competition's prices they don't take the drive time/visit cost overhead into consideration. By ignoring the drive time/visit cost, in fact they are undermining the importance of location which is counterintuitive since they also believe that location is extremely important. Presto provides a formal technique account for drive time/visit cost differences among different retailers and to make the price comparisons more realistic.

Retailers have always known that price is a very important factor in consumer decision making and bears a strong relationship with sales volume. However, they also know that there are many other important factors as well. For e.g., in-store advertising or actions such as putting items on end cap displays, allocating more/prominent shelf space, results into higher sales volume. Similarly, they know that competition's prices also affect sales volume. But either the retailers or software vendors who provide demand optimization/price optimization solutions to retailers primarily analyze the relationship between retailer's prices and retailer's sales volume to predict demand and recommend optimal prices. That is why they cannot easily explain why the sales volume of an item may significantly fluctuate even if a retailer does not change the price of the item. Presto takes a comprehensive view of the factors that affect the demand of a product and establishes a mathematical relationship among those factors to produce the best demand elasticity measurement.

Typically retailers collect competition's prices with varying frequencies—for some items every week, other items every 4 weeks, some other items every 8 weeks/quarter etc. This frequency in most situations does not bear a relationship to the frequency when competitors change their prices. Also, the retailers themselves change the prices of their items at different frequencies. In addition, after collecting the competition's prices, it takes the retailers several days/weeks to react to competition's prices. Thus in effect in most situations, retailers react to the past prices of competition and not to the current prices. By devising mathematical methods to predict competition's prices, Presto makes retailer's pricing process proactive and makes retailer's prices better aligned with competition's prices/market prices.

Although retailers know that competition impacts their revenues and margins they don't have any way measuring such impact in quantitative terms and hence they really cannot use it for effective decision making. Presto is the only system that provides the methods and tools to measure the impact of competition on retailer's sales and margins and enables them to predict what impact competition will have on retailer's future performance, allowing them to implement counter strategies.

The invention encompassing these new and useful systems methods and apparatus is further described below. These and other advantages and features of the invention will be more readily understood in relation to the following detailed description of the invention, which is provided in conjunction with the accompanying drawings.

### BRIEF DESCRIPTION OF THE DRAWINGS

FIG. 1 shows various aspects of the invention in schematic block diagram form including a schematic representation of a computing device adapted to store a plurality of data elements in a computer memory device and to retrieve and process one or more of said data elements to produce a report including decision information for the sale of consumer goods;

FIGS. 2A and 2B show various aspects of the invention in tabular form;

FIG. 3 shows further aspect of the invention in schematic block diagram form;

FIGS. 4-8 show various aspects of the invention in flow chart;

FIG. 9 shows further aspects of the invention in schematic block diagram form;

FIG. 10A-12 show further aspects of the invention in tabular form;

FIGS. 13-28 show further aspect of the invention including schematic or presentations of user interface display portions of the invention along with related annotation; and

FIG. 29 shows a computer processing device according to one aspect of the invention.

### DETAILED DESCRIPTION

The following description is provided to enable any person skilled in the art to make and use the disclosed invention in its various aspects. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present inventions.

Therefore, according to certain aspects of the present invention, predictive market data is produced based on an automated analysis of acquired current and historical competitive factors data. In various embodiments, the acquired current and historical competitive factors data includes competitive pricing data.

Through careful and creative effort, the inventor has arrived at several important and novel observations and conclusions that, in turn, lead to useful, new and non-obvious solutions which, together, form the invention as here described. Thus, the inventor understands that retailers and consumer goods suppliers and manufacturers use various strategies, tools, beliefs, goals and targets and personal intuition in determining pricing for various goods. The personnel involved in these activities include merchandising executives, buyers and pricing managers at headquarters and store levels, as well as various elements of consumer-facing management. These strategies, tools, beliefs, goals and people are relatively static or inelastic in the short run.

The inventor has observed that retailers and consumer-goods manufacturers tend to react to macroeconomic factors such as increases in gasoline prices, transportation charges, commodity price changes, weather changes, credit restrictions, etc. in a predictable manner. These macro factors generally affect every player in a given market. Major promotions by manufacturers can have a similarly broad effect on a market. By applying novel automated analysis to these factors, it is possible to arrive at conclusions related to the arrangement, distribution and pricing of tangible goods that would be substantially impossible to achieve with manual or intuitive methods.

Another important conclusion is that store demographics and consumer profiles are relatively well understood and are largely inelastic in the short run. Consumer buying habits and behavior are also substantially inelastic in the short run. In like fashion, the short-run competition profile of a particular store is substantially inelastic.

The inventor has also realized that total discretionary income of all consumers in a trade area, to which the store belongs, is fairly predictable. Similarly, the total discretionary income that all consumers in a trade area are willing to allocate to a particular category of goods can be ascertained with a fair degree of accuracy. Further, consumer price sensitivity relative to an item category or an item follows a predictable pattern in the short run.

Other relatively inelastic factors important in predicting future retail pricing include the short run interrelationships among items in the mind of retailers and consumers. These interrelationships are reflected by item placement, price relationships between different items, promotions, deals, advertisements and contents of consumer market baskets, etc. It should be noted that retailers often try to create and maintain a certain price image, and target well-identified consumer segments. The inventor has consequently concluded that a majority of underlying factors are either static or follow a pattern of behavior and can be usefully predicted.

In response to their novel understanding of the issues and problems associated with retail goods pricing, the inventor has developed an integrated automated merchandising recommendation system. Referred to, in certain embodiments, as the “Presto Merchandising Recommendation System” the system, method and apparatus of the invention operates by analyzing the consumers' demographic, the competitive profile and other characteristics (such as transportation factors and weather) of a market. In addition, according to the invention, merchandising strategies determined to be the most appropriate merchandising strategies for the market under consideration are developed. In certain aspects, the invention provides direct input to operational systems responsible for pricing, product assortment, marketing and in-store merchandising practices of a retailer and recommends prices at store group, product category and items level. In various aspects, these recommendations are aimed at achieving the best possible financial results in terms of market share, store traffic, revenue, sales volume and profitability.

According to one aspect of the invention, market share is used as a weighting factor in determining weighted market share for a particular item. In such an embodiment, market analysis results are queried to determine a market share factor for each market participant with respect to the particular item. In like fashion, market analysis results are queried to determine a current price for each market participant with respect to the particular item. Multiplying each market share for the particular participant value by a respective current price for that participant yields a weighted price with respect to the particular participant. Thereafter, according to one embodiment, arithmetically averaging the weighted prices produces a weighted average price for the particular item in the subject marketplace.

Throughout most of this document, the terms “retailer”, “manufacturer”, “wholesaler” and “supplier” are used interchangeably. Exceptions to this rule include situations in which a relationship between two or more of these entities is indicated; for example, a relationship between a retailer and manufacturer that supplies goods to that retailer. The term “target store” is used to indicate one or more stores, groups of stores, or other entity, on behalf of which the system, method and apparatus of the present invention are to be applied. The term target store is used interchangeably with the term “my store” throughout the present application.

Although various actions and results are described in a narrative sequence herewithin, it should be understood that the steps of various embodiments of the described method are to be performed in any appropriate order according to the desired results of a particular application. Thus the order of presentation of elements and aspects of the invention in the present text and drawings is not to be considered in any way limiting.

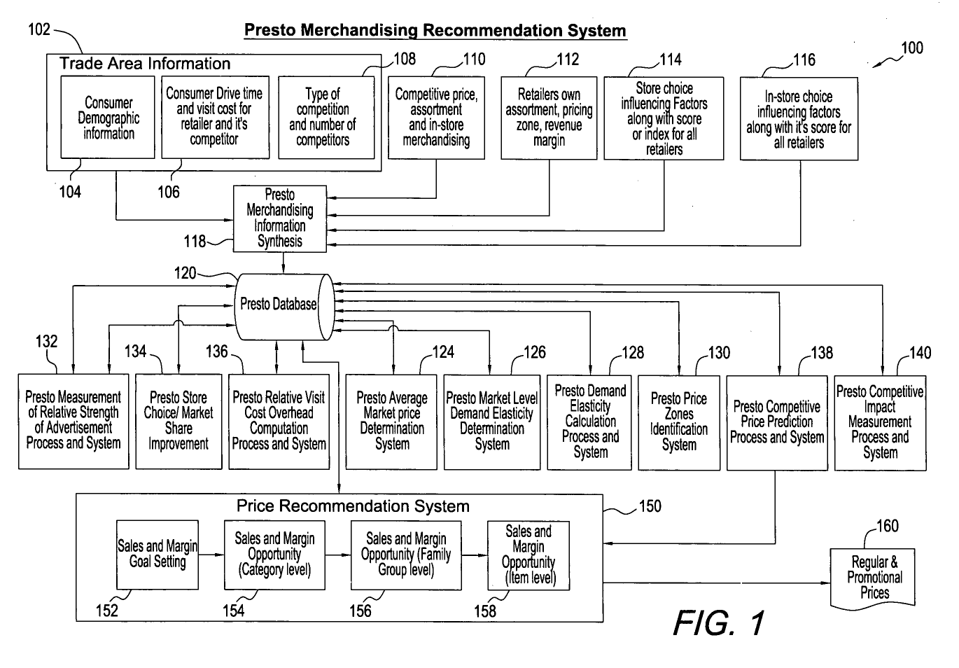

FIG. 1 shows, in schematic block diagram form, a portion of a consumer goods price prediction and optimization system and apparatus according to certain aspects of the invention. As illustrated, the invention includes an automated system 100 adapted to receive, synthesize and store information in a computerized database (referred to, in certain embodiments, as the “Presto Database”). In various embodiments, the information includes trade area information 102 (such as consumer demographic information 104, consumers' drive times and visit costs to go to the store of the retailer and to that of a competitor 106, type of competition 108, number of competitors etc.). Other included information includes competitive price, assortment and in-store merchandising information 110 and a target retailer's own assortment, movement, pricing, zone, revenue and margin information 112; store choice influencing factors along with a score, ranking or index for each of the store choice influencing factors in relation to each retailer in a market 114 and in-store product choice influencing factors, along with a score, ranking or index for the each of the in-store product choice influencing factors in relation to each retailer in the market 116.

In certain aspects of the invention, data representing trade area information and other information is stored in a physical configuration of a computer storage medium. In various embodiments, the physical configuration of the storage medium includes one or more of a pattern of pits on an optical medium, a pattern of magnetic domains on a magnetic medium, a pattern of interference generating marks on a holographic storage medium, and any other local or remote medium embodying any appropriate technology, for example.

As illustrated, at least a portion of the stored information is received for automated analysis at a processing device. The processing device is configured as an automated system adapted to effect an information synthesis 118. This information synthesis results in further changes in the states of the physical system, so as to represent resulting synthesized data. The synthesized data is then received at a database 120 (Presto Database). As will be further discussed below, information in the database 120 is used to develop store choice, market share, and market share improvement, indicators and reports (Presto Store Choice/Market Share Improvement).

The hardware of the database management system is operated, generally under software control, to provide a quantitative rationale for retailer's and competitors' market shares by analyzing the factors which influence consumers' store choice; create optimal recommendations for improving retailer's market share; and provide those recommendations to pricing, product assortment, marketing and in-store merchandising systems. Data from the database 120 is, thus, received at the processing device.

The processor device (such as, e.g., a special-purpose or general-purpose computer CPU) is configured, in one aspect, as an average market price determination system 124 adapted to determine an average price for an item or product family (Presto Average Market Price Determination System) leveraging market shares of the retailers in the market as the weights for the prices charged by the retailers and visit costs (drive time converted into financial terms) associated with each retailer in the market as an overhead for the prices charged by the retailers. Calculation results of the average market price determination system 124 are received as output of the system 100 and also are received into the database 120 to support further calculations and operations of the processor device.

The processing device is configured, in a further aspect, as an automated processing system to determine market level price elasticity of an item or product family 126 (Presto Market Level Demand Elasticity Determination System) by using average market price in that market and total market volume sold in that market of that item or product family. As with the average market price determination system 124, the results of the market level demand elasticity determination system 126 are received as output of the system and also are received into the database 120 to support further calculations and operations of the processor device.

In other aspects, the invention includes an automated process to analyze relationships between retailer's revenues, sales volume, store traffic and profit margins; retailer's prices, product assortment, advertisement and in-store merchandising/causal factors in retailer's own stores in relation to competitors' prices, product assortments, advertisement and in-store merchandising/causal factors and calculating demand elasticity for retailer's offerings using a statistical multifactor regression analysis technique 128 (Presto Demand Elasticity Calculation Process and System).

In yet another aspect, the invention includes an automated process and a system to identify the number of price zones of a retail chain and associating stores of that retailer to identified price zones 130 (Presto Price Zones Identification System) using the pricing and assortment information of the retailer. The operation of this subsystem includes identifying number of prices prevalent for an item in a geographical market across different stores of the retailer and by identifying mathematical relationship among prices of items at different stores of a retailer.

According to still further aspects and embodiments, the invention includes an automated process and a system to measure the relative strength of advertisement of the retailer in a market 132 (Presto Measurement of Relative Strength of Advertisement Process & System).

Further aspects of the invention are found in a system method and apparatus adapted to determine a Store Choice Index/Market Share Improvement 134 (Presto Store Choice Index/Market Share Improvement Process and System). According to these aspects and embodiments of the invention, an automated process is provided that uses factors which influence the decision of the members of a consumer segment to visit a store or other channel of the retailer and retailer's competitor's in a geographical area. In addition, the automated process uses a target retailer's and each of their competitor's relative ranking for each of the influence factors.

The present process determines the relative weight of each of the influence factors using statistical multiple regression analysis to arrive at an index number that represents the Store Choice or market share % of the retailer and each of the competitors. Thereafter, the process aggregates the Store Choice Index for a given set of Consumer Segments and/or a given set of stores and uses the cost and time frame required to improve each of the influence factors for the retailer. According to the process, a user enters one or more financial goals of the target retailer (such as increasing revenues or increasing market share) and the time frame in which the one or more goals are expected to be achieved. The system then creates recommendations for the most cost effective course of action to achieve the one or more financial goals by identifying the influence factors which need to be changed, the degree to which they need to be changed and the cost and time frame necessary to change them. In certain embodiments, the system also provides the recommendations to another computer system, such as a price recommendation system, an assortment recommendation system, a marketing system or an in-store merchandising programs recommendation system.

In other aspects, the invention includes an automated process to maintain the drive time required by the members of a consumer segment to visit a store of a retailer and the stores of each its competitors; to compute their visit cost by considering the drive time and the cost of transportation; to add the visit cost to the cost of items that they buy at the store and to arrive at the aggregate cost of an item which includes the price paid to the retailer for that item and the visit cost overhead; and to use such aggregate visit cost for comparing the cost of items at the retailers and its competitors 136 (Presto Relative Visit Cost Overhead Computation Process and System).

In other aspects, the invention includes an automated process and a system to usefully predict, the regular and promotional prices a certain competitor will charge for a certain item at a certain store location in, for example, the next 4 to 12 weeks; to analyze the differences among the predicted and actual prices; and to refine the assumptions used for predicting the prices 138 (Presto Competitive Price Prediction Process and System).

In other aspects, the invention includes an automated process and a system to maintain a list of factors that affect the demand of an item or a group of items; to use statistical multiple regression analysis techniques to identify the relative weight of each of those factors; to analyze the differences among the predicted and actual prices; to refine the assumptions on an on-going basis to better reflect the changing weights of the different factors; and to introduce new temporary or permanent factors 140 (Presto Competitive Impact Measurement Process and System).

As indicated above, information from the database 120 is mutually exchanged with a price recommendation system 150. The price recommendation system 150 is configured into include a combination of a processor device and operative software. In addition, in certain embodiments the price recommendation system 150 receives information from at least the competitive price prediction process and system 138.

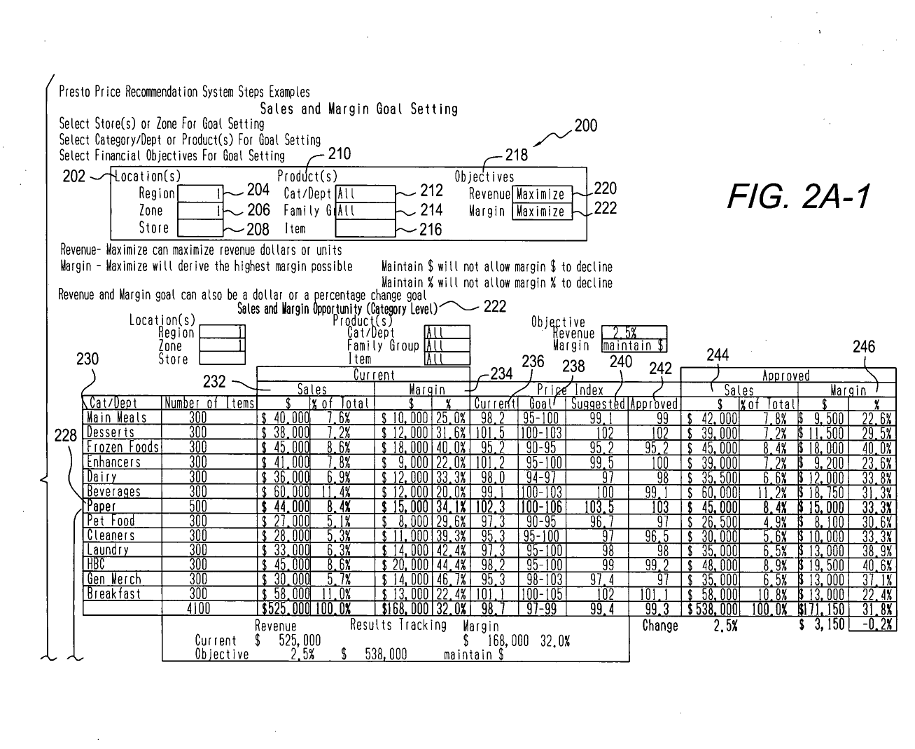

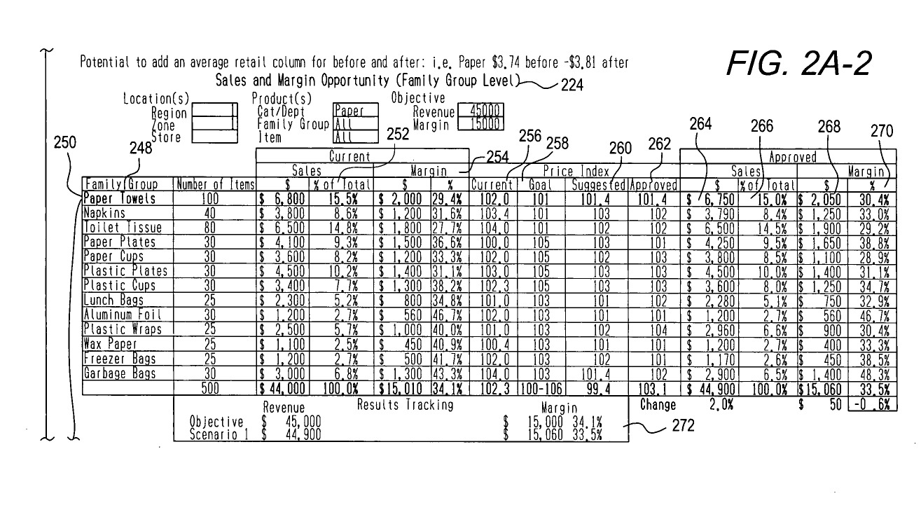

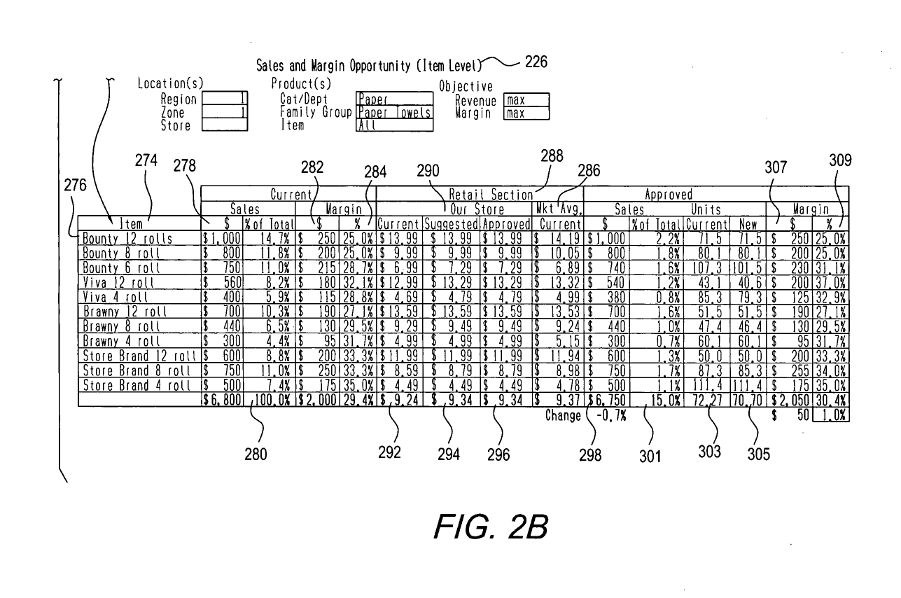

The price recommendation system 150 includes a first sales and margin goal setting portion 152. As will be discussed below further in relation to FIG. 2, operational parameters are established in the sales and margin goal setting portion sales and margin goal setting portion 152 which are then applied in the operation of a category level sales and margin opportunity portion 154, a family group level sales and margin opportunity portion 156 and an item level sales and margin opportunity portion 158. Output values and results 160 of the price recommendation system are presented to a user either electronically or in permanent form depending on the requirements of a particular application.

FIG. 2 shows an exemplary illustration of sales and margin goal setting values, arranged according to an exemplary user interface presentation 200. One of skill in the art will appreciate that a wide variety of user interface mechanisms are possible, any of which are anticipated to be within the scope of the invention according to requirements of a particular application and embodiment.

As shown in FIG. 2, operation of the price recommendation system 150 of FIG. 1, allows a user to identify a location 202 for analysis by, for example, region 204, zone 206 and store 208. By selecting or entering appropriate values, an appropriate location for analysis is identified. Likewise, products for analysis 210 can be identified by entering or selecting according to category or department 212, family group 214, and item 216, for example. Similarly, the user can identify objectives 280 characterizing the analysis to be performed, such as e.g., maximizing revenue 220 and maximizing margin 222. It should be noted that the illustrated input variables and values are merely exemplary and additional input values could be presented in an alternative embodiment.

The selections made above, for location 202, products 210 and/or objectives 218, are carried forward and provide the basis for calculations reflected at category level 222, family group level 224 and item level 226 (see FIG. 2B). Accordingly, at the category level 222 which relates to categories or classes of items (such as, e.g., paper items 228) classes or groups of items are displayed 230 according to a selection 212 made above.

In response to the above-noted selections, and reflecting values stored in the database 120 (FIG. 1), corresponding current sales 232 and current margins 234 values are presented for consideration by a user. Corresponding current price index values 236 and goal price index values 238 are also presented, and based on these values, suggested price index values 240 are calculated by the system and apparatus of the invention for consideration by a user. According to one method of using the system and apparatus of the invention, a user can either accept a suggested price index value (as provided 240) or enter an alternative approved value into column 242. Of course it should be appreciated that presentation and entry by column, as shown, is purely exemplary and is not limiting. It should likewise be appreciated that other user interface arrangements fall equally well within the scope of the invention.

In certain embodiments, the system calculates and displays approved sales 244 and margin 246 values showing dollar values, and percent of total sales, for review and consideration by the user.

The presentation, as well as the method of operation and calculations discussed above are extended to the family group level 224 based on the values entered at the category level 222 (corresponding to family group level number 156 shown in FIG. 1). Thus, the category level selections of values for the category paper 228 are reflected at the family group level 224 in a list 248 including, for example, paper towels 250.

As at the category level, current sales 252 and margin 254 values are presented in dollar and percentage terms for each item of the family group. Similarly, current 256 and goal 258 price index values along with suggested 260 and approved 262 price index values. The user, upon reviewing the suggested price index values as an opportunity to accept those values or to answer alternative values at 262.

Approved sales and margin values are calculated and presented in dollar value and percentage value outputs respectively 264, 266, 268, 270. Corresponding results tracking values are summarized and presented 272.

As shown in FIG. 2B the user interface approach described above with respect to the category level 222 and the family group level 224 is similarly applicable to the item level 226. Thus individual items 274 in the family group paper towels 250 are displayed, e.g. Bounty 12 rolls 276.

Columns of values are presented showing current sales in dollar values 278 and percentages 280 as well as current margins in dollar values 282 and percentages 284. Market average prices 286 are presented in dollar values for reference in a retail section 288. Shown in conjunction with these are current store values 290 for the target (user's) store. The current store values 290 include current price 292 a (possibly different) suggested price 294 as calculated by the system, and an approved price 296 which is either a default value, calculated by the system as suggested price, or an alternative value entered by the user.

Based on the approved values 296, and values from the database 120 of FIG. 1, the system calculates and presents approved values on a per-item basis for sales dollars 298, sales percentages 301, current units 303, new units 305, and margin in dollar value 307 and percentage 309.

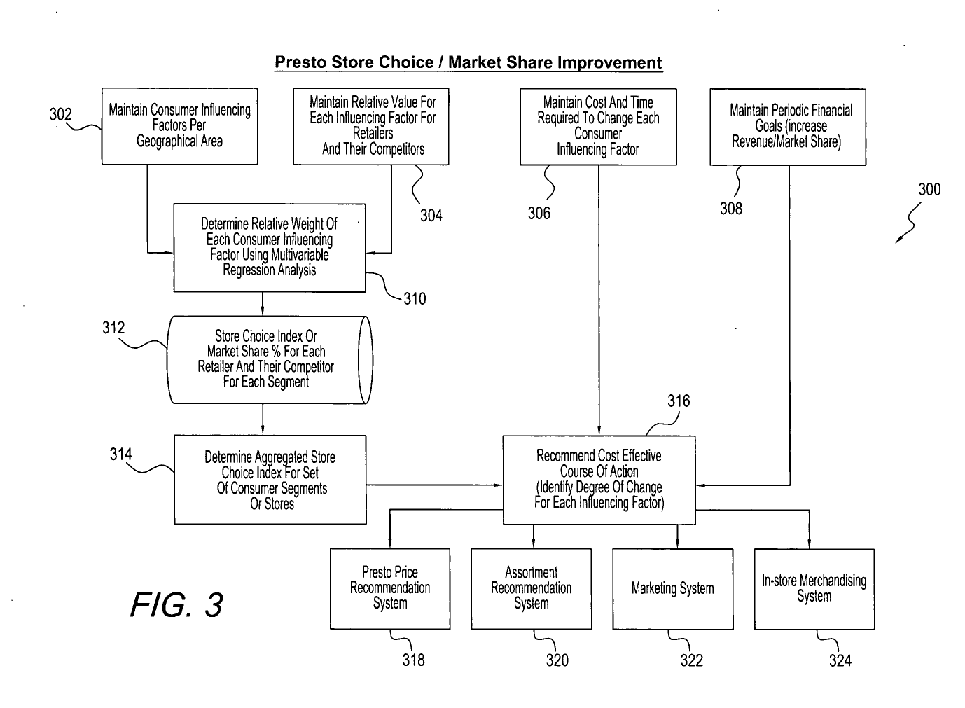

FIG. 3 shows, in schematic block diagram form, a portion 300 of a model according to certain aspects of the invention. As indicated, various data sets are maintained for processing. One of skill in the art will understand that maintenance of these data sets includes, in various embodiments, the storage of data on magnetic storage media in the form of magnetic domain orientations, any other embodiments storage of data on optical media in the form of, for example, pitted plastic material. The configuration of pitted plastic material in optical storage media is substantially permanent, and the orientation of magnetic domain in magnetic storage media often persists for months, years, or even decades.

In one aspect, operation of model portion 300 includes maintaining consumer influencing factors categorized by geographic area 302. In another aspect, operation of model portion 300 includes maintaining relative value for each influencing factor for retailers and their competitors 304. Also maintained are cost and time data required for maintenance of each consumer influencing factor 306 and periodic financial goals data, with respect to increased revenue/market share 308.

In a further operative step, model portion 300 includes determining a relative weight of each consumer influencing factor using multivariable regression analysis 310. Thereafter, operation of the model portion 300 includes calculating a store choice index (or market share percentage) for each target store retailer and for each of one or more competitors 312.

Based on the store choice index for the target store and competitive store(s) an aggregated stored choice index is determined 314 for a set of consumer segments (and/or for a set of stores). The aggregated store choice index determined at 314 serves as input to a further processing step 316, which also accepts as input cost and time data 306 and periodic financial goals data 308. The further processing step 316 includes recommending a cost-effective course of action by identifying a degree of change for each influencing factor. Processing step 316 produces, a plurality of outputs that are received, for example, by a price recommendation system portion 318 of the invention, an assortment recommendation system portion 320 of the invention, a marketing system portion 322 of the invention and in-store merchandising system portion 324 of the invention.

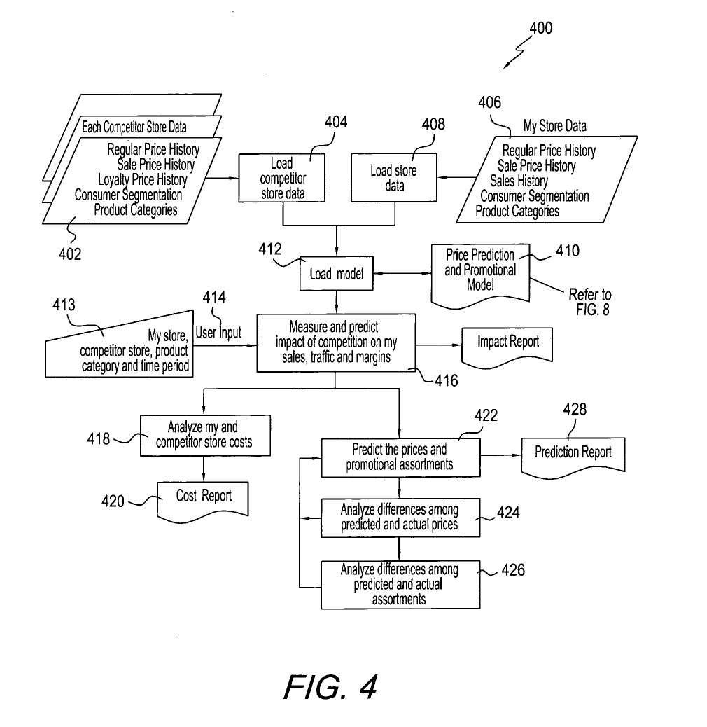

FIG. 4 illustrates, in block diagram form, certain aspects of the invention including a portion of an operative method 400 of a price prediction modeling apparatus. As shown, the operative method 400 includes receiving 402 a set of competitive data from each of one or more competitive entities (hereinafter referred to as stores) i.e., competitive store data. Exemplary aspects and components of the competitive store data include regular price history, sale price history, loyalty price history, consumer segmentation and product categories.

Received competitive store data is loaded 404 for processing. In certain embodiments of the invention, the loading of competitive store data is effected by the storage in a physical memory device. According to certain embodiments of the invention, a complete data set of competitive store data is loaded concurrently within a physical memory device. In other embodiments of the invention, portions of a data set of competitive store data are sequentially loaded into, and deleted from, a typical memory device. In still other embodiments of the invention, the receipt and loading of data is performed according to the demands a particular calculation.

As also shown in FIG. 4, store data is received 406 for the target store. As in the case of the competitive store data, target store data includes, in exemplary aspects and components, regular price history, sale price history, loyalty price history, consumer segmentation and product categories. Received target store data is loaded 408 for processing. As in the case of competitive store data, the target store data may be loaded in whole or in part and in various orders according to the requirements of respective particular embodiments and implementations of the invention.

Further illustrated in FIG. 4, operative program data, forming at least a part of a price prediction and promotional model, is stored 410 in a physical configuration of a storage medium. In various embodiments, the physical configuration of the storage medium includes one or more of a pattern of pits on an optical medium, a pattern of magnetic domains on a magnetic medium, a pattern of interference lines on a holographic storage medium, and any other local or remote medium embodying any appropriate technology, for example. In a further method step, all or a portion of the operative program data is loaded 412 into a processor portion of a computing apparatus for computational control of the computing apparatus.

In a further step of the present method, target store and competitive store product category and time period information is retrieved from a corresponding portion of a data store device 413 and/or is entered by user input 414 from a user interface device and received by the computing apparatus. The computing apparatus conducts processing 416 of appropriate portions of the above-noted information according to the price prediction and promotional model 410. The processing includes measurement and prediction of an impact of competitive factors on sales, traffic and margins of the target store. Also included in the processing is analysis 418 of target store and competitive store costs to produce an output cost report 420.

In addition, the aforementioned processing includes a processing step 422 adapted to predict the pricing and promotional assortments of competitive store goods and classes of goods. A further processing step 424 is adapted to analyze differences among predicted and actual prices, and still another processing step 426 is adapted to analyze differences among predicted and actual assortments and classes of goods. As illustrated, the results of these analyses are, according to certain embodiments and aspects of the invention, received as recursive inputs to processing step 422. Upon the determination of certain processing results, a prediction report, often but not exclusively in the form of a tangible paper report, is produced 428.

According to certain aspects of the invention, processing 416 includes application of absolute and relative differences between retailer and supplier prices as compared with competitive prices, and relates these differences to differences in sales movement/volume and dollar value. Included in the processing 416 is analysis of loyalty and local customer segmentation information to identify, by store, consumer segments that prefer the target store over the competitive store.

In further aspect of the invention processing 416 includes the identification of consumer segments that do not shop at the target store, or that shop at the target store less frequently than at competitive stores. Processing 416 also includes the analysis of consumer segment specific market baskets to identify relative costs in the target store and one or more competitive stores.

In operation, the illustrated operative method 400 is adapted to measure and predict the impact of competition on sales, traffic and margins of a particular good or class of goods. In certain embodiments, this measurement and prediction is effected on the subject goods by store, competitor, product category, consumer segmentation and time period.

The creative practitioner of ordinary skill in the art will appreciate that the operative method 400 can be implemented in a price prediction modeling apparatus including, for example, a special-purpose computer processor device, a general-purpose computer processor device, or any other technologically appropriate device in the present art, or that may be forthcoming.

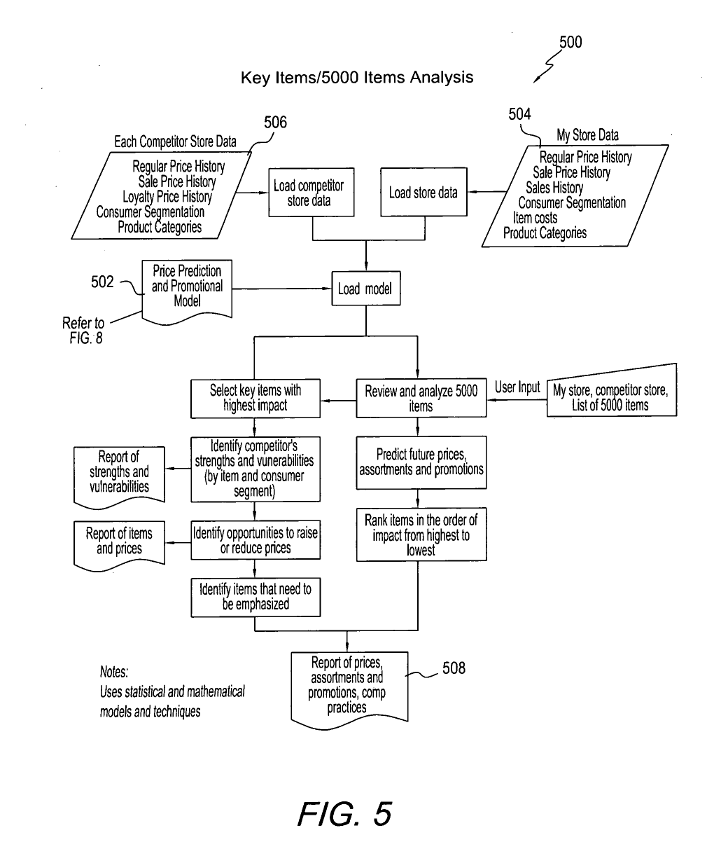

The creative practitioner of ordinary skill in the art will be familiar with the graphical notation practiced here and will readily understand and appreciate further aspect and details of the invention upon reviewing the additional figures present in this disclosure. Among these are FIG. 5 which shows a key items analysis 500 that uses price prediction and promotional model 502 to evaluate target store data 504 and store data 506 from each competitive store to produce a report 508 of prices, assortments and promotions, as well as comparative practices.

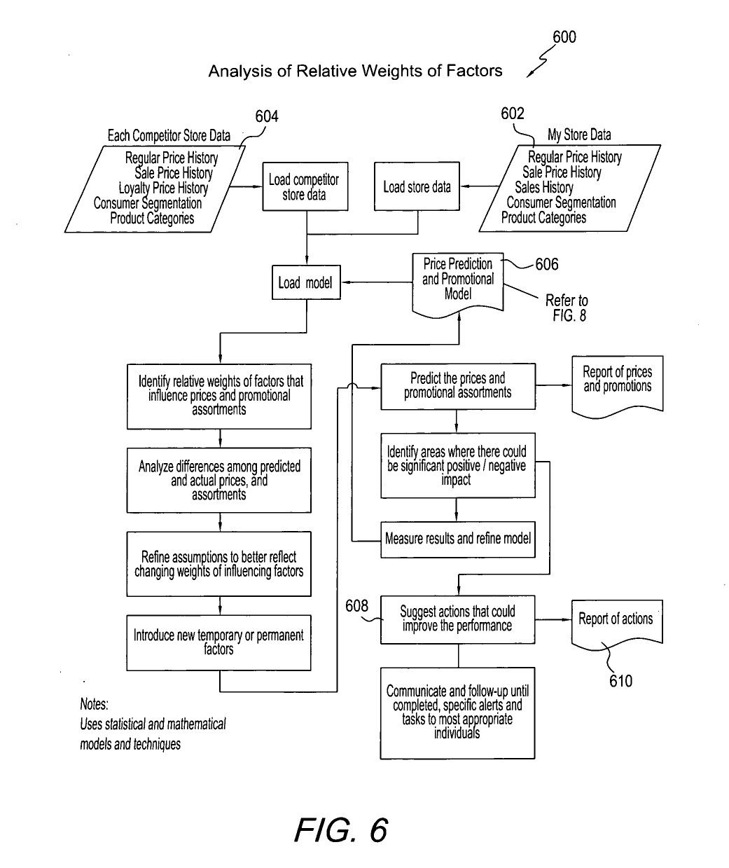

FIG. 6 shows a further aspect of the invention including an analysis of relative weights of factors 600. The analysis 600 proceeds by receiving target store data 602 and competitive store data 604, loading a price prediction and promotional model 606, and evaluating the input data 602, 604 under the model 606 to produce suggestions for actions that could improve performance 608 as well as a report of actions 610.

A method related to operation of the model 606 to produce an analysis of relative weights of factors 600 would, in one embodiment, include the steps of identifying relative weights of factors that influence prices and promotional assortments; analyzing differences among predicted and actual prices and assortments; refining assumptions to better reflect changing weight of influencing factors; introducing new temporary or permanent factors; predicting the prices and promotional assortments; identifying areas where there could be significant positive and/or negative impacts; suggesting action that could improve performance; communicating specific alerts and tasks to the most appropriate individuals in, for example, merchandising, marketing, pricing and store management; following up until the suggested actions are completed; and measuring results. In light of the foregoing, one of ordinary skill in the art would readily understand and be able to implement various details required for operation of this method.

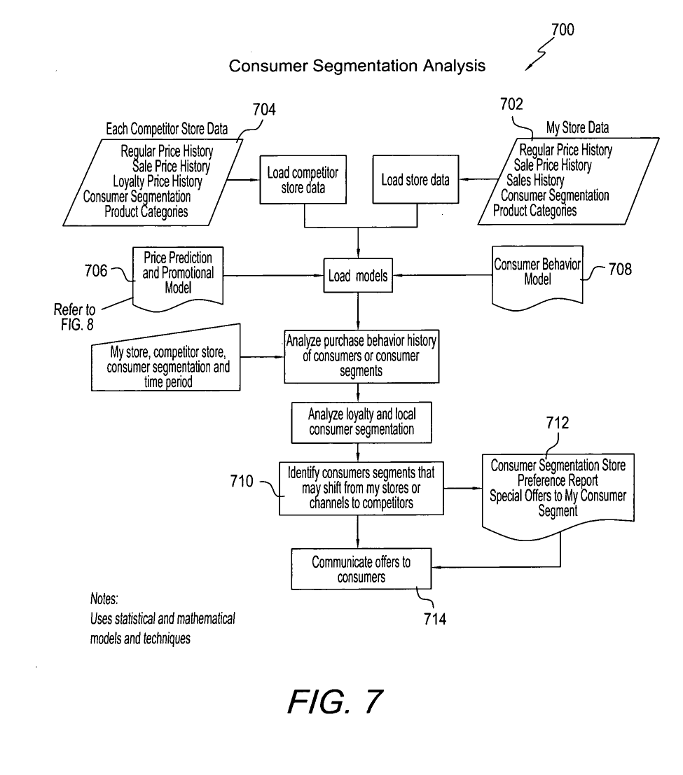

FIG. 7 shows a further aspect of the invention including a consumer segmentation analysis 700. The analysis 700 proceeds by receiving target store data 702 and competitive store data 704, loading a price prediction and promotional model 706 as well as a consumer behavior model 708, and evaluating the input data 702, 704 under the models 706, 708 to identify 710 consumer segments that may shift from target stores or channels to competitors. In addition, according to certain embodiments, a system according to the invention produces a consumer segmentation store preference report 712 identifying possible special offers for presentation 714 to the target stores consumer segment.

A method related to the analysis 700 would, in certain embodiments, include the steps of assisting the supplier and/or retailer in identifying the consumer segments that are more amenable to shifting from their stores or channels to their competitors or from their competitors to them. This evaluation would proceed by reviewing visit and purchase behavior history of the consumers or consumer segments; performing comparative market after pricing; evaluating price elasticity; evaluating competitors past and predicted prices and assortments; and taking offensive or defensive action to secure market share.

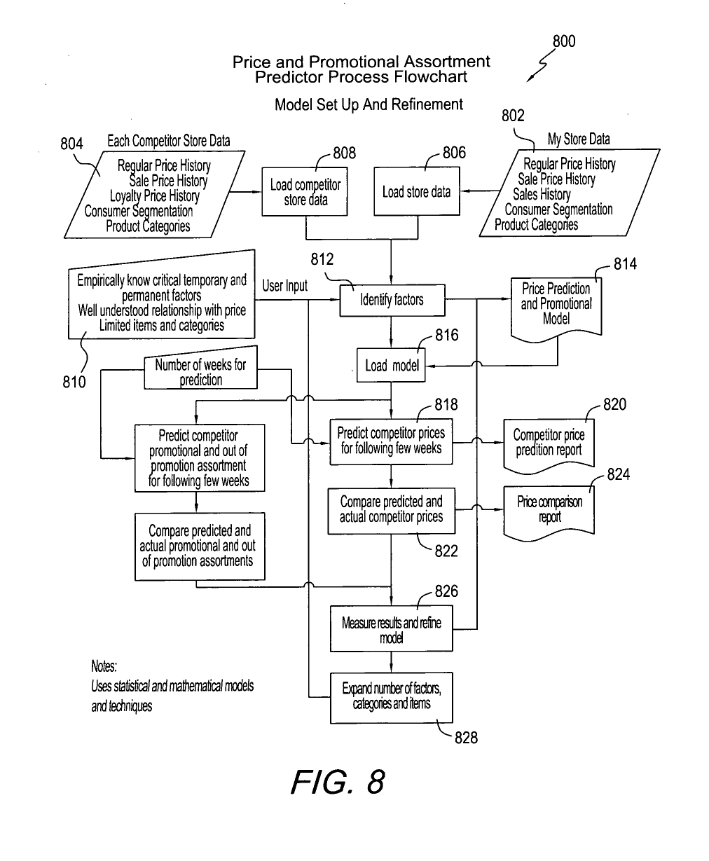

FIG. 8 shows, in flowchart form, a further aspect of the invention including the elements and operation of a price and promotional assortment predictor system 800. The system 800 operates by receiving target store data 802 and competitive store data 804. The target store data and competitive store data 802, 804 is loaded 806, 808 and evaluated with empirically known critical temporary and permanent factors 810 to identify factors 812 for price prediction and promotional modeling 814. The factors 812, along with a price prediction and promotional model 814 are loaded 816 and the model executed by operation of an automatic processor.

Operation of the model produces predictions of competitor prices 818 for a subsequent time interval. The predicted competitor prices are, in some embodiments, available as a hardcopy report 820. Thereafter, predicted and actual competitor prices are compared 822, and a price comparison report 824 is developed.

The model 814 is refined based on an evaluation 826 of the predicted and actual competitor prices. Among the possible response of actions is an expansion 828 in the number of factors categories and items evaluated by the model.

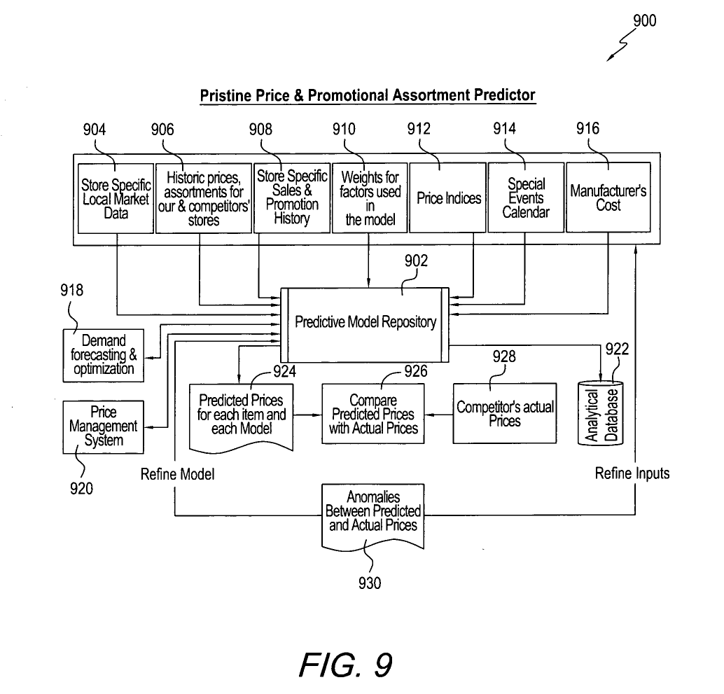

FIG. 9 shows another embodiment of a system 900 according to the invention. As shown in FIG. 9 data from various data sets are receiving to a predictive model repository 902. The various data sets include store specific local market data 904, historic prices, assortments for target store and competitive stores 906, store specific sales and promotion history 908, weights for factors used in the model 910, price indices 912, special event calendars 914, and manufacturers cost data 916. The predictive model repository exchanges data mutually with a demand forecasting optimization portion 918 of the system and with a price management system 920. An analytical database 922 receives data representing the conclusions developed by the model 902. The model 902 also produces, in some embodiments, a report 924 reflecting predicted prices for each item and each model. Thereafter, predicted prices are compared 926 with competitors actual prices 928, and anomalies between predicted and actual prices are reported 930.

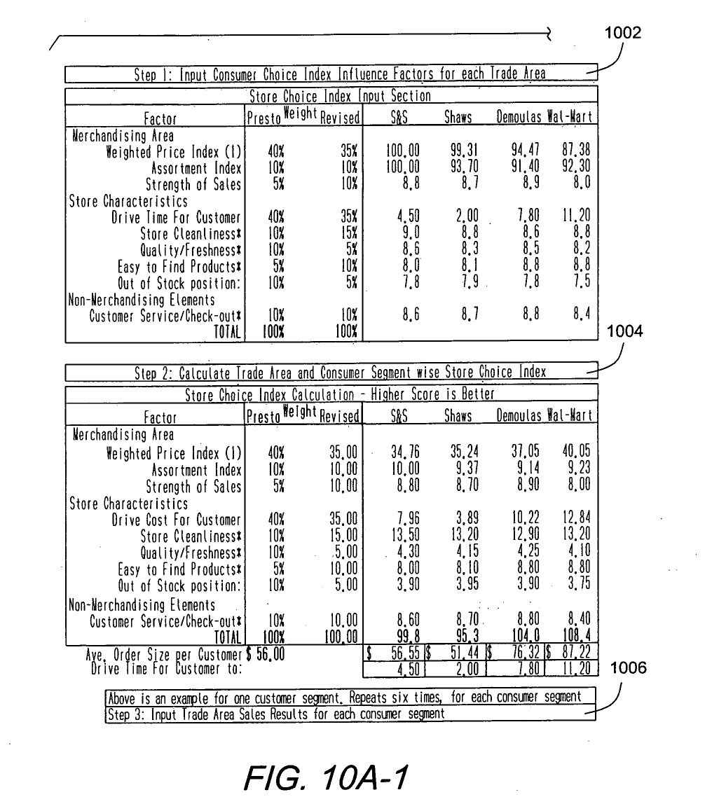

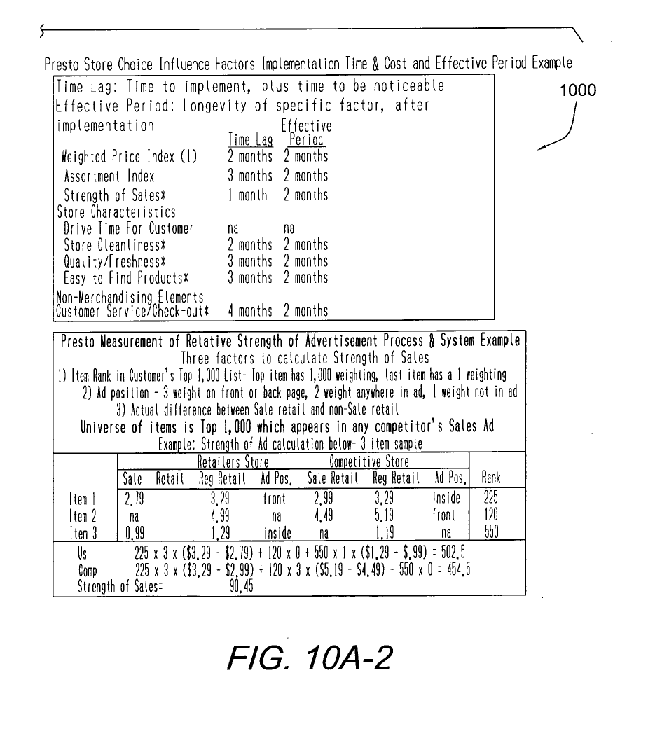

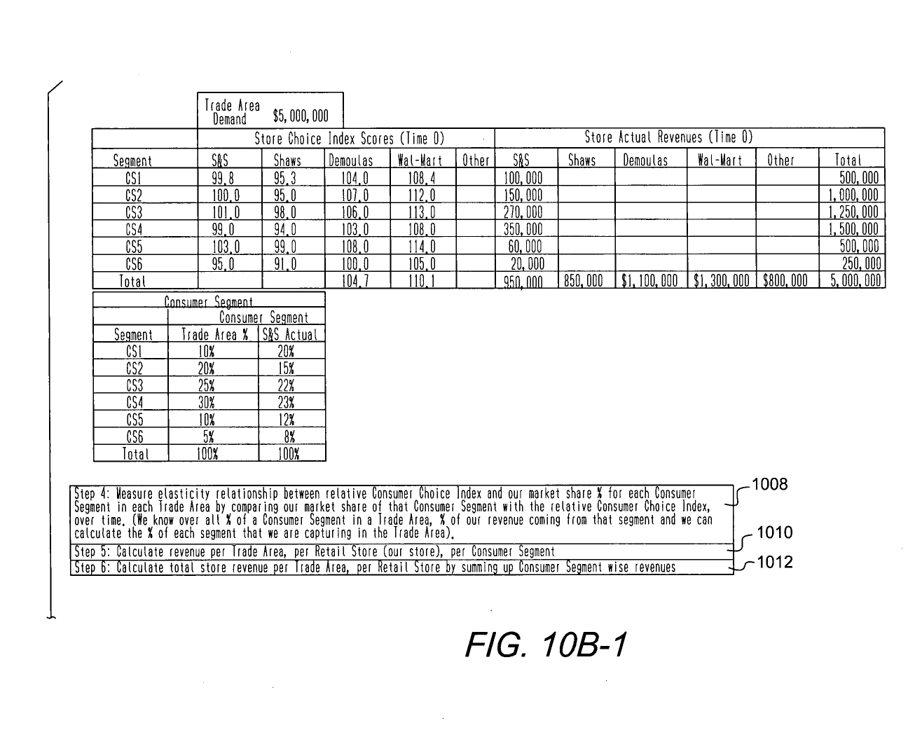

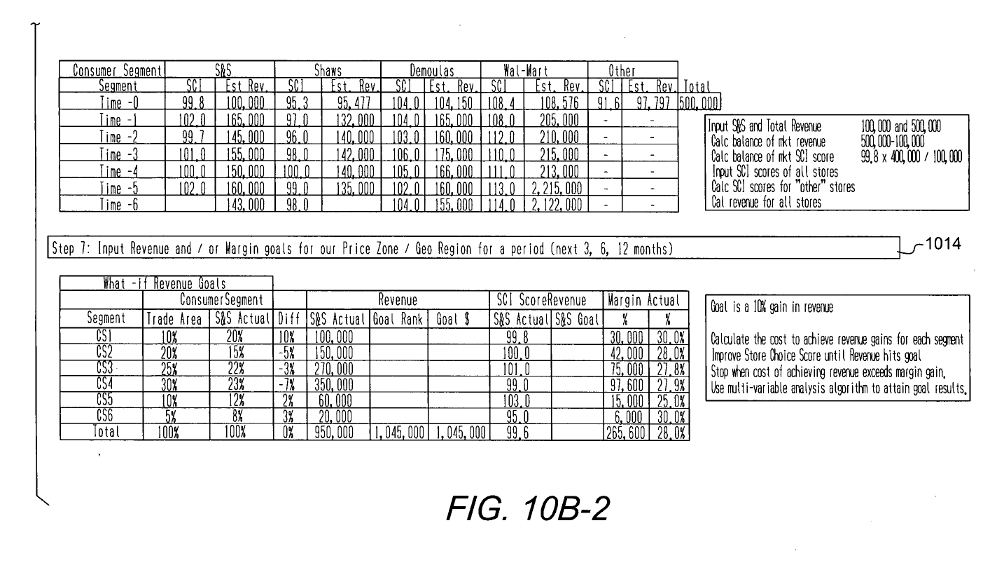

FIGS. 10A and 10B elucidate the steps involved in operating a portion 1000 of an exemplary system according to the invention. In addition, FIGS. 10A and 10B illustrate one exemplary user interface approach for such an embodiment of the invention. Accordingly, a method according to a portion of the invention includes the steps of inputting consumer choice index influence factors for each trade area 1002; calculating trade area and consumer segment wise store choice index 1004; inputting trade area sales results for each consumer segment 1006; measuring an elasticity relationship between relative consumer choice index and target store market share percentage for each consumer segment in each trade area by comparing the target store market share of that consumer segment with the relative consumer choice index, over time 1008; calculating revenue per trade area, retail store (i.e., target store) per consumer segment 1010; calculating total store revenue per trade area, retail store by summing up consumer segment wise revenues 1012; and inputting revenue and/or margin goals for target store price zone/geographic region for a time interval (such as e.g., a subsequent 3, 6 or 12-month time interval) 1014.

In light of the foregoing, “S&S” is presented as the target store. Competitive stores include Shaws, DeMoulas, Wal-Mart, and others.

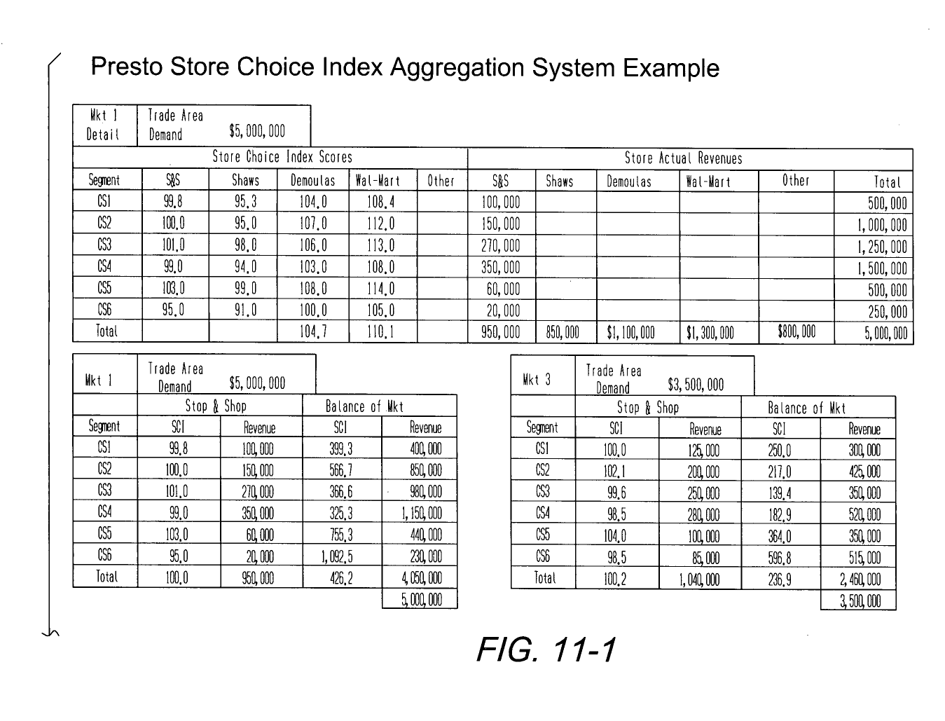

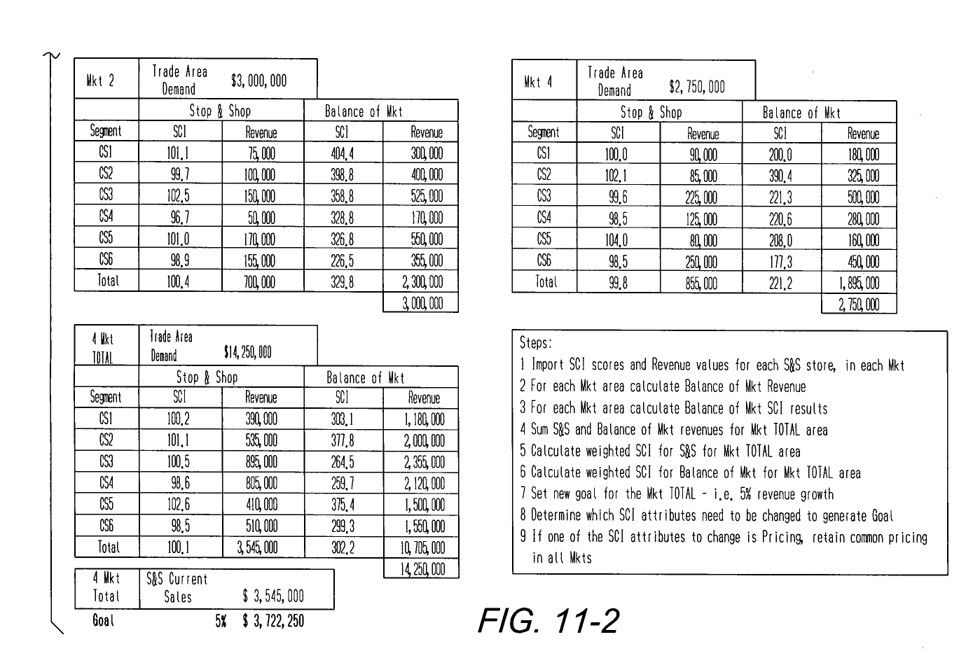

FIG. 11 illustrates a store choice index aggregation system example. Store choice index scores, representing market share, along with trade area demand, are used to develop sales goals in terms of percentage and dollar value.

A method of applying this portion of the system of the invention, according to aspect of the exemplary embodiment includes the steps of importing SCI scores and revenue values for each target store market; for each market area calculating balance of market revenue; for each market area calculating balance of market SCI results; summing target store and balance of market revenues for market total area; calculating weighted SCI for target store for market total area; calculating weighted SCI for balance of market for market total area; setting new goals for the market total (e.g., 5% revenue growth); determining which SCI attributes need to be changed to generate goal; and if one of the SCI attributes to change is pricing, retain common pricing in all markets.

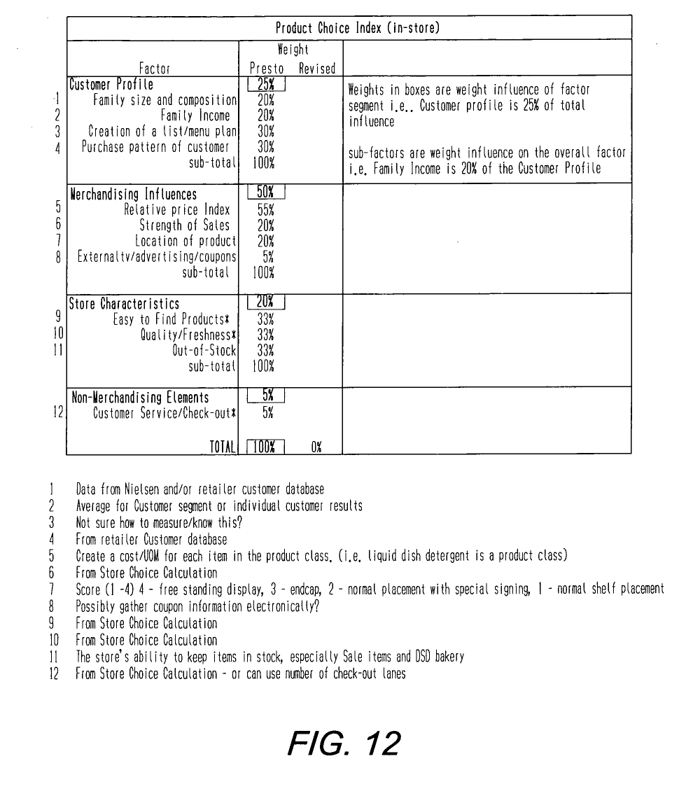

FIG. 12 shows, in tabular form, factors to be applied in developing a product choice index. As shown commodities factors include customer profile, merchandising influences, store characteristics, and non-merchandising elements.

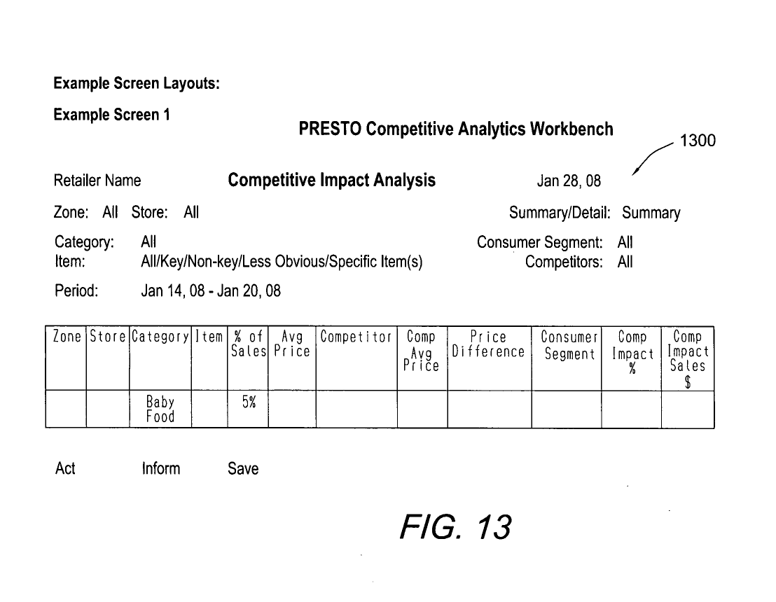

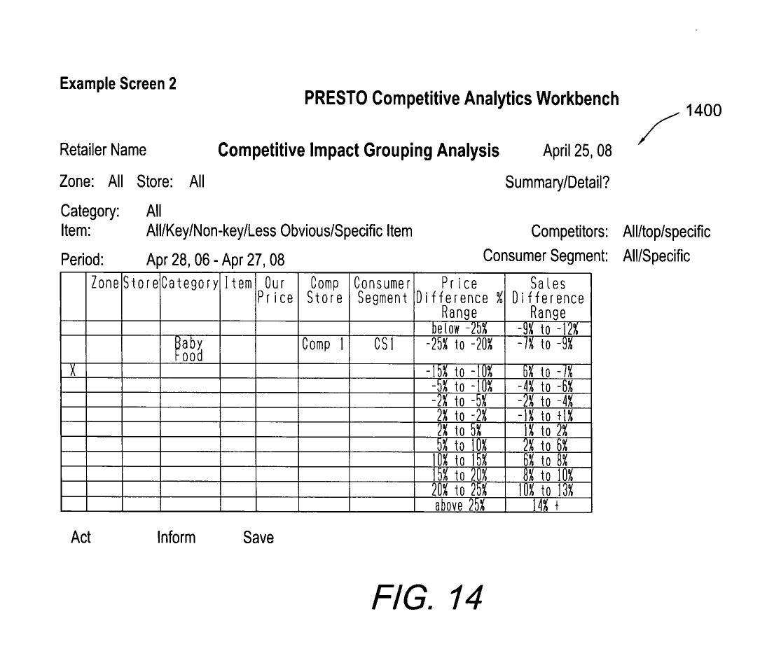

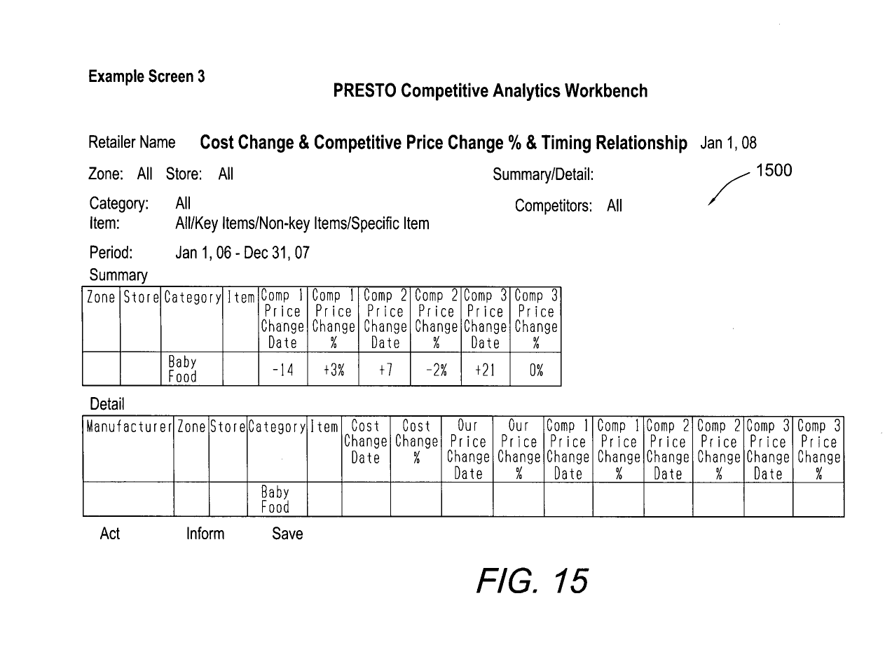

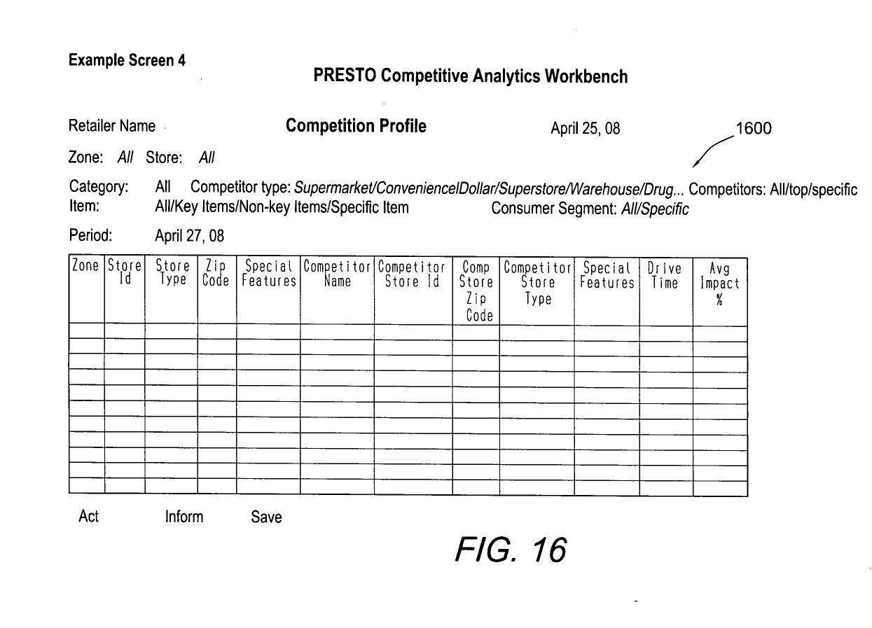

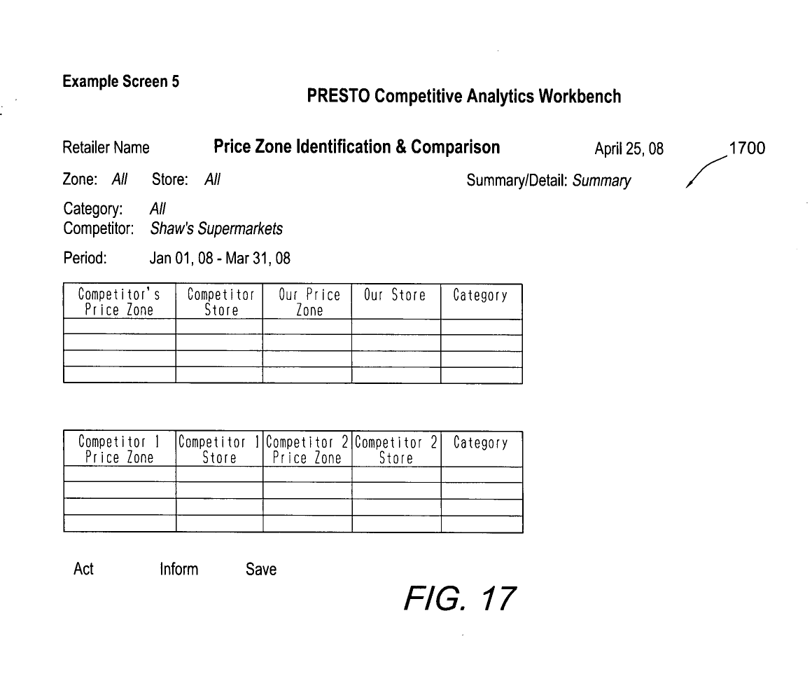

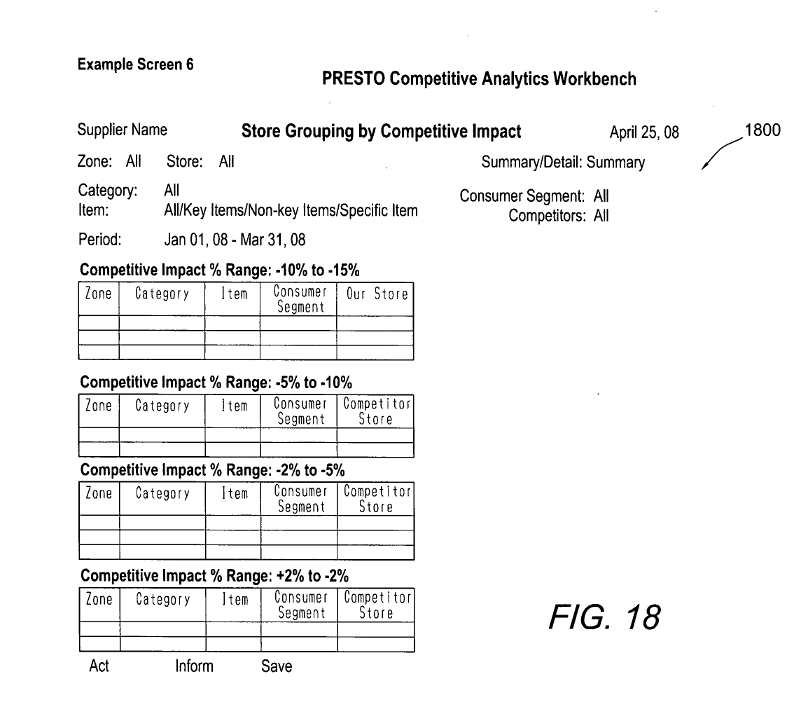

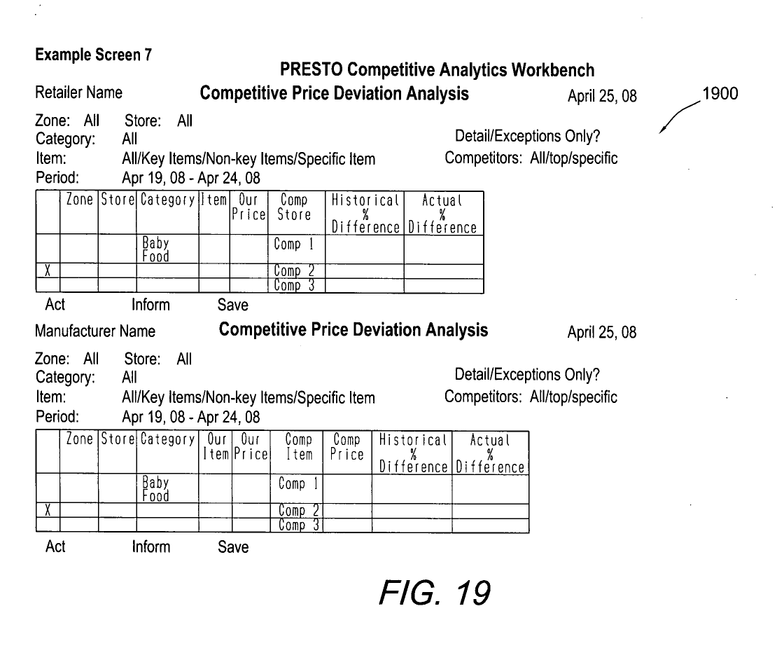

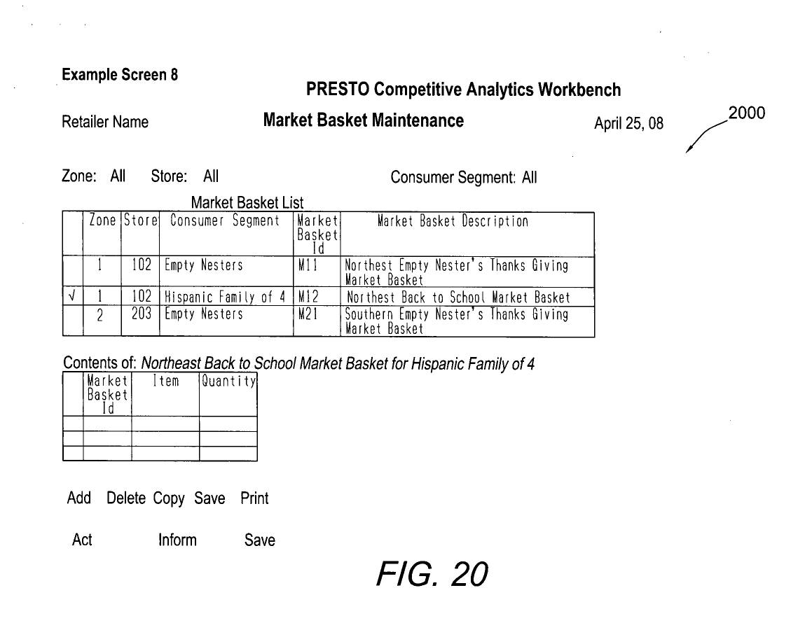

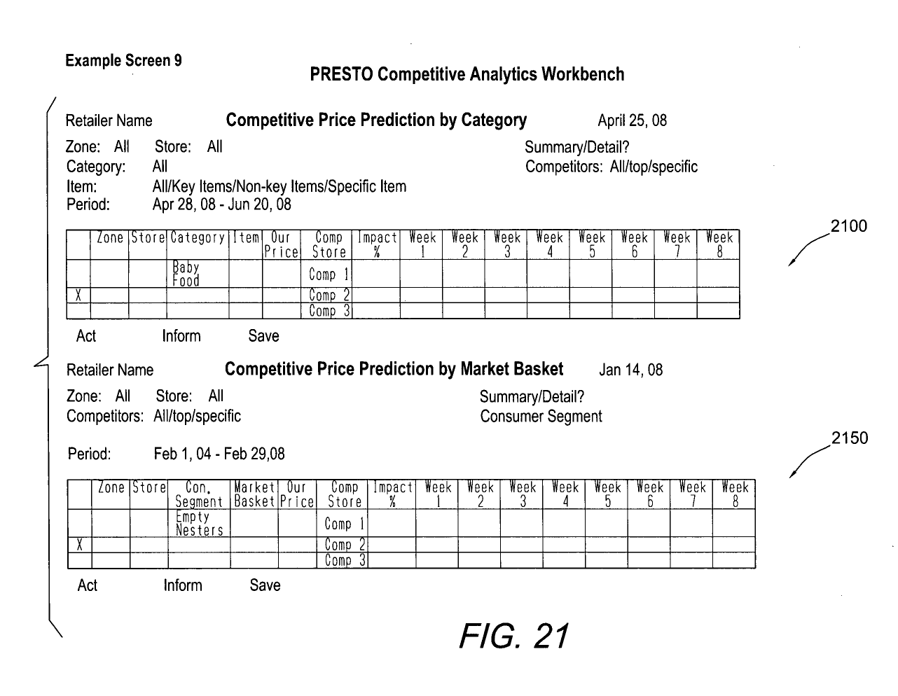

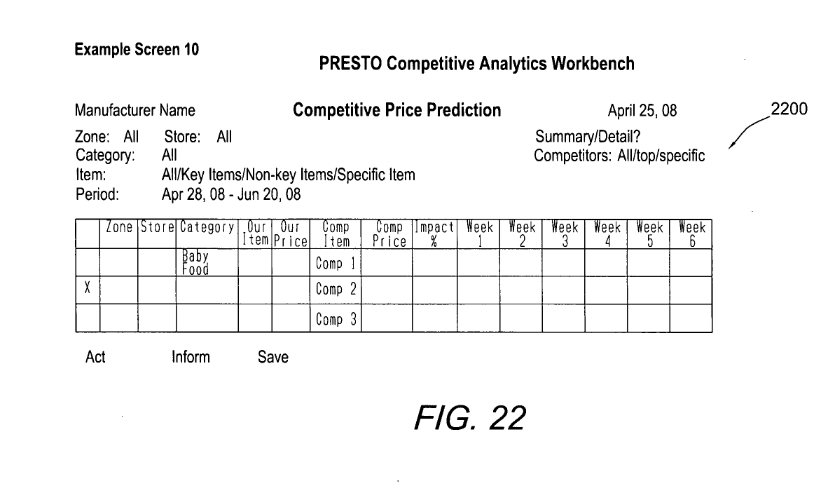

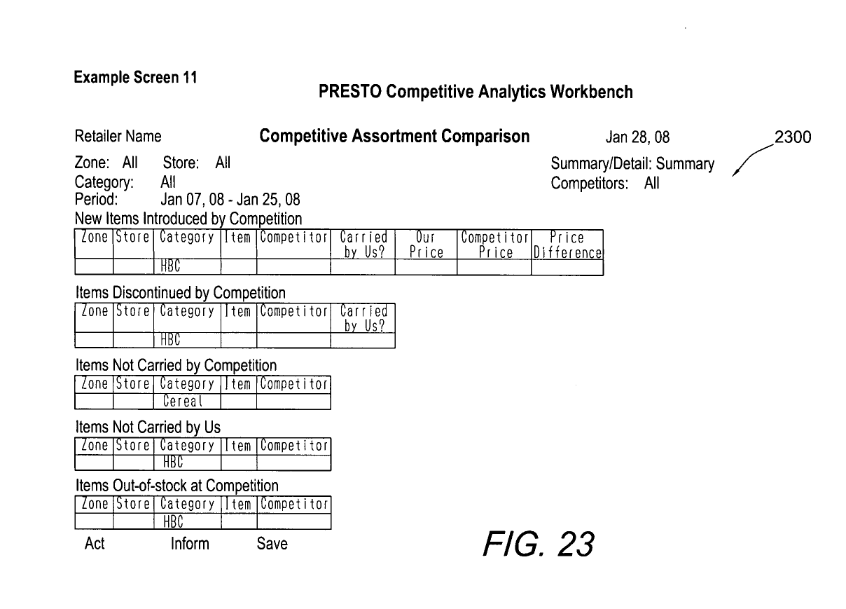

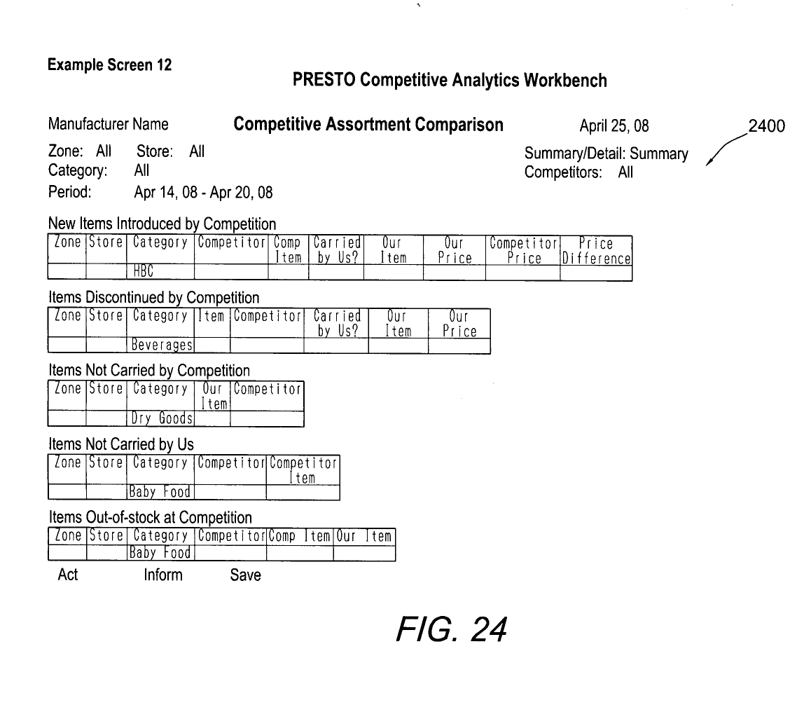

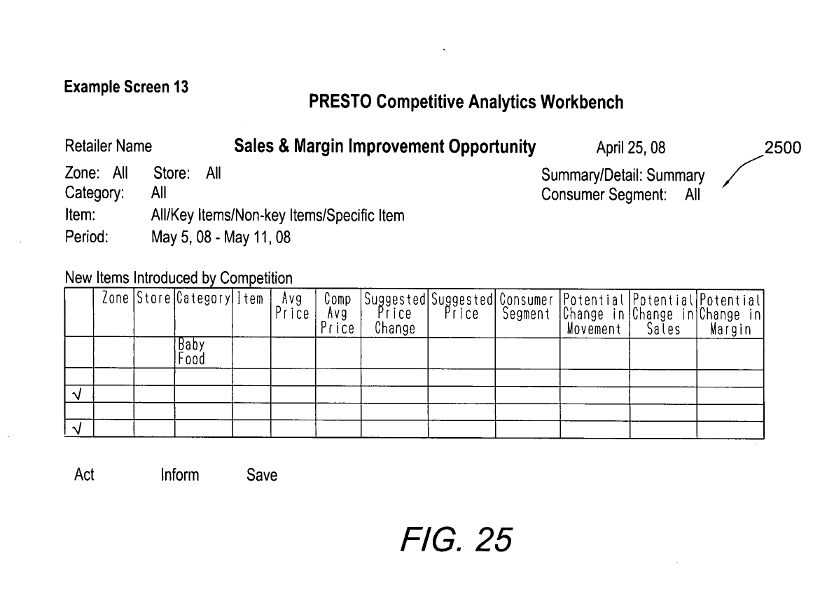

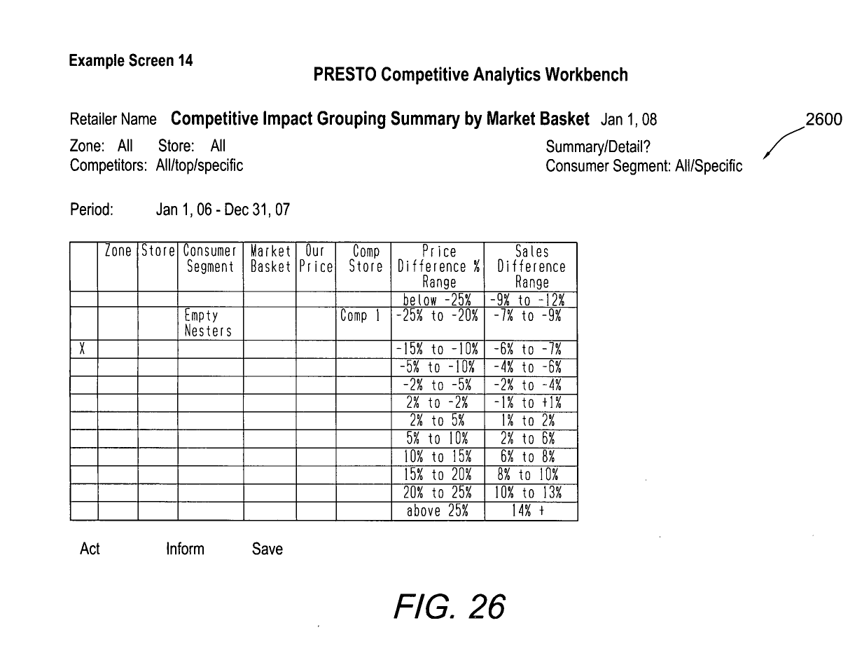

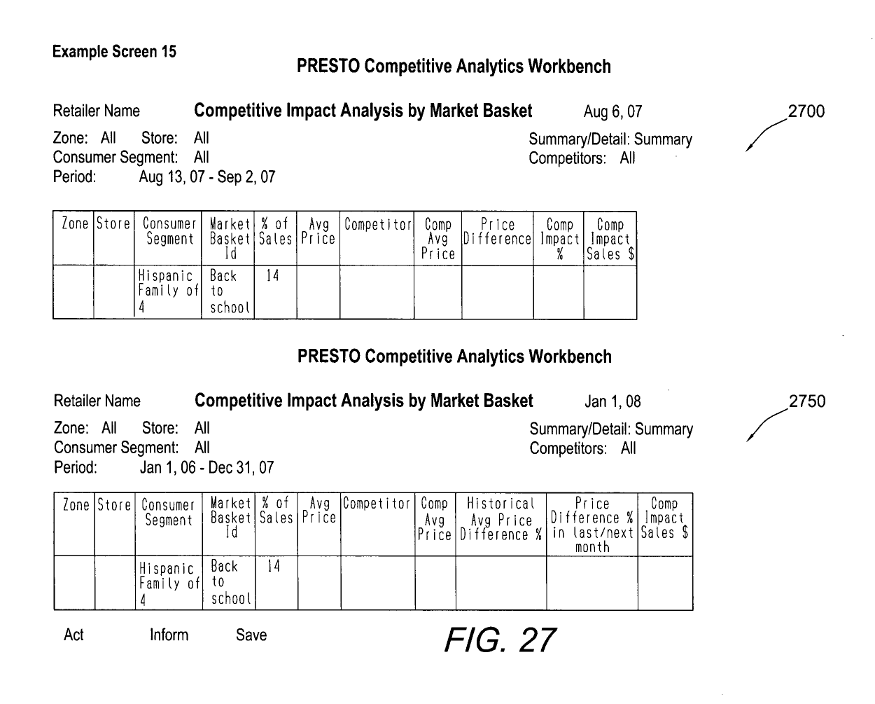

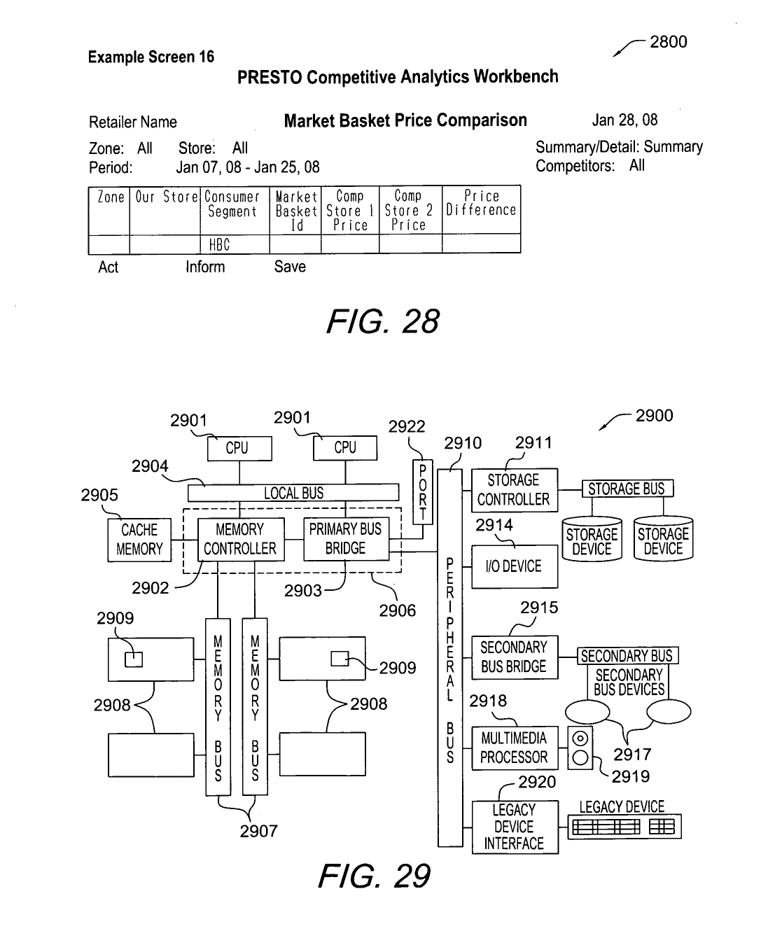

FIGS. 13-28 show, in various aspects, a further exemplary embodiment of the invention, including aspects of a user interface layout and an approach for a competitive analytics. FIG. 13 shows an exemplary user interface layout and various aspects of a competitive impact analysis 1300. FIG. 14 shows a user interface layout and various aspects on a competitive impact grouping summary 1400. FIG. 15 shows a user interface layout and various aspects of a cost change and competitive price change percentage and timing relationship 1500. FIG. 16 shows a competition profile 1600. FIG. 17 shows a price zone identification and comparison portion 1700 according to the invention. FIG. 18 shows store grouping by competitive impact 1800. FIG. 19 shows competitive price derivation analysis 1900. FIG. 20 shows market basket maintenance 2000. FIG. 21 shows competitive price prediction by category 2100 and competitive price prediction by market basket 2150. FIG. 22 shows competitive price prediction 2200. FIG. 23 shows competitive assortment comparison 2300. FIG. 24 shows further examples of competitive assortment comparison 2400. FIG. 25 shows sales and margin improvement opportunity 2500. FIG. 26 shows competitive impact grouping summary by market basket. FIG. 27 shows competitive impact analysis by market basket 2700 and a further example of competitive impact analysis by market basket at a later analysis date 2750. FIG. 28 shows a further market basket comparison 2800.

According to certain further aspects of the invention, an exemplary embodiment includes a consumer choice index and store choice index evaluating portion that evaluates strength of advertisement, and that recommends which factors to change, what such change will cost, and how much time change will take. In certain embodiments, a system according to the invention is adapted to provide suggestions as to a best course of action. Additionally, in certain embodiments, the system is adapted to identify how consumers distribute their income and demand across different formats and channels of distribution. The system evaluates product choice when consumers are inside the target store, and evaluates drive time and visit cost.

In certain embodiments, a system according to the invention includes speaker independent natural voice-enabled in-store merchandising and price data capture. In further embodiments, a system provides in-store merchandising factors for alkylating demand elasticity including factors in the retailer's own store (such as e.g., out of stock) and factors in a competitive store.

A still further aspect of the invention includes an automated process and method for price and assortment recommendation providing both strategy and the identification of preferred actions.

In another aspect, the invention includes an automated process adapted to synthesize trade area information, competitive price, assortment and in-store information, a retailer's (i.e. target store's) own assortment, movement, pricing, zone, revenue and margin information.

Still another aspect of the invention includes providing automated process for intelligent aggregation of product and category hierarchy, geographical hierarchy and analyzing the same using statistical techniques. In addition, in various embodiments, the invention includes finding a number of prices prevalent for an item in a geographical market across retailers, finding a number of prices prevalent for an item in a geographical market across different stores of a single retailer or manufacturer, and finding an average market price for an item or product family by leveraging market share information. Further aspects of the invention, in certain embodiments, include finding market level elasticity of an item or product family, as well as automatic identification of numbers of price zones and assortment analytics. Also included are techniques for improving price check data quality using statistical techniques and methods for identifying price image items for each consumer segment.

In further aspects, a method according to the invention includes a method for selecting items to price check based on price change frequency at a competitor, and/or based on a retailer's own price change frequency, and/or triggered by a cost change and/or by any other appropriate threshold transition or factor.

In still other aspects, the invention includes a market observation mechanism and includes identifying whether a retail associate is moving unreasonably faster inactivity as well using precise indoor location tracking techniques to determine in-store location of a person, asset, product and/or activity.

A further understanding of a system according to certain aspects of the invention, and of an invented method of using such a system will become clear to one of ordinary skill in the art when one considers the procedure of reviewing, for example, 45,000 items every week for every store and each competitor, and leveraging statistical and mathematical modeling techniques, internal cost changes, competitors' past behavior in relation to each store/geography, item/category, other retailers, elasticity parameters etc., to predict the future prices, assortment and promotions and identify the categories and items and consumer segments where the competitor is likely to be stronger or vulnerable with respect to a certain consumer segment. According to this method, one can use a system according to the invention to select a very small number of items (say 50 items) per category where action would be likely to have a highest measurable impact. Thereafter, the system can be used to identify a competitor's strengths and vulnerabilities item by item and consumer segment by consumer segment.

Based on the foregoing, a system according to the invention can determine where the competitor is higher or lower than other players in the market, and also can identify items and goods that the competitor carries or does not carry. In addition, a user can compare the status of the competitor to existing and/or anticipated consumer demand. Based on this analysis the system can identify opportunities to raise and/or reduce prices. Objectives can be identified and used to select either key items or less obvious items or a combination thereof. In addition, items can be identified that need to be emphasized in marketing or in consumer communications, or that need to be in or out of a weekly advertisement channel.

Other features of a system according to the invention include an ability to rank goods in order of impact from, for example, highest to lowest, an ability to select, say, 300 less obvious items per store for which there is an opportunity to raise prices by, say, $0.10 for the week, and to revise prices, promotion and marketing tactics and comp shop practices. In further aspects of the invention, a system can be configured to initiate the execution of price changes, weekly ads, messaging, displays etc., as well as to initiate the measurement of results and to initiate the recalibration of models.

According to still another aspect of the invention, a system is prepared that is adapted to evaluate both a retailer's costs and a competitor's prices so as to identify whether a relationship exists between these inputs. In such relationship exists, the system is, in certain embodiments, adapted to highlight when there is a significant change in that relationship area such change might, for example, indicate an upcoming cost change for the retailer, or that the competitor is getting a better or worse deal from a manufacturer or supplier as compared to the arrangements provided by that manufacturer or supplier to the user.

A further example illustrating aspect and characteristic of the invention in a system according the invention include a method of solving the problem how to attract customers. According to a method of the invention a system is provided that if it's in implementing tactics to attract a competitor's customers and to motivate one's own customers to buy more and buy additional items from one's own store instead of visiting a competitive store. For example, using information from a loyalty card, local demographic, and location, as well as external information sources such as Nielsen® and IRK®, suppliers and retailers can determine where the customer resides in which consumers reside in communities that have a shorter or more convenient commute to the competitor's store versus one's own store.

A retailer can also identify consumers who have signed up for the retailer's loyalty program but who, nevertheless, do not shop much in the retailer's store. With this information in hand, the retailer can identify more productive customers who are demographically similar to the target customers, but who tend to buy more. Thereafter, the retailer can identify what goods the more productive customers tend to purchase and establish what it will cost to buy the same things at the next nearest competitor. On this basis, the retailer can establish attractive pricing and, in some instances, target advertising so as to increase purchases by the desired customer. In certain instances, specific offers can be targeted to the desired customer.

By comparing the consumer segment specific, and the time of year/special event specific market basket, one can identify what consumers are not buying from a user. Thereafter one can check whether there is a significant difference between one's own prices and those of a competitor with respect those items in the market basket. Using consumer segmentation specific price elasticity, and a measure of the impact on a competitor's store on one's own store, the system can, on a store by store basis, identify which customers have the potential for increasing the number of trips or expanding the market basket, or for giving one's own store a try.

It should be understood that the above-described invention can be limited on a special purpose processing device, on a specialized computer, on a particular computer, on a particular general-purpose computer, and on any other appropriate automatic processing device such as is known or may become available in the art.

FIG. 29 illustrates an exemplary computer processing system 2900. The processing system 2900 includes one or more processors 2901 coupled to a local bus 2904. A memory controller 2902 and a primary bus bridge 2903 are also coupled the local bus 2904. The processing system 2900 may include multiple memory controllers 2902 and/or multiple primary bus bridges 2903. The memory controller 2902 and the primary bus bridge 2903 may be integrated as a single device 2906.

The memory controller 2902 is also coupled to one or more memory buses 2907. Each memory bus accepts memory components 2908. Any one of memory components 2908 may contain a semiconductor chip.

The memory components 2908 may be a memory card or a memory module. The memory components 2908 may include one or more additional devices 2909. For example, in a SIMM or DIMM, the additional device 2909 might be a configuration memory, such as a serial presence detect (SPD) memory. The memory controller 2902 may also be coupled to a cache memory 2905. The cache memory 2905 may be the only cache memory in the processing system. Alternatively, other devices, for example, processors 2901 may also include cache memories, which may form a cache hierarchy with cache memory 2905. If the processing system 2900 include peripherals or controllers which are bus masters or which support direct memory access (DMA), the memory controller 2902 may implement a cache coherency protocol. If the memory controller 2902 is coupled to a plurality of memory buses 2907, each memory bus 2907 may be operated in parallel, or different address ranges may be mapped to different memory buses 2907.

The primary bus bridge 2903 is coupled to at least one peripheral bus 2910. Various devices, such as peripherals or additional bus bridges may be coupled to the peripheral bus 2910. These devices may include a storage controller 2911, a miscellaneous I/O device 2914, a secondary bus bridge 2915, a multimedia processor 2918, and a legacy device interface 2920. The primary bus bridge 2903 may also be coupled to one or more special purpose high-speed ports 2922. In a personal computer, for example, the special purpose port might be the Accelerated Graphics Port (AGP), used to couple a high performance video card to the processing system 2900.

The storage controller 2911 couples one or more storage devices 2913, via a storage bus 2912, to the peripheral bus 2910. For example, the storage controller 2911 may be a SCSI controller and storage devices 2913 may be SCSI discs. The I/O device 2914 may be any sort of peripheral. For example, the I/O device 2914 may be a local area network interface, such as an Ethernet card. The secondary bus bridge may be used to interface additional devices via another bus to the processing system. For example, the secondary bus bridge may be a universal serial port (USB) controller used to couple USB devices 2917 via to the processing system 2900. The multimedia processor 2918 may be a sound card, a video capture card, or any other type of media interface, which may also be coupled to additional devices such as speakers 2919. The legacy device interface 2920 is used to couple legacy devices, for example, older styled keyboards and mice, to the processing system 2900.

The processing system 1300 illustrated in FIG. 8 is only an exemplary processing system with which the invention may be used. While FIG. 8 illustrates a processing architecture especially suitable for a general-purpose computer, such as a personal computer or a workstation, it should be recognized that well known modifications can be made to configure the processing system 1300 to become more suitable for use in a variety of applications. For example, many electronic devices that require processing may be implemented using a simpler architecture that relies on a CPU 301 coupled to memory components 308 and/or memory devices 309. The modifications may include, for example, elimination of unnecessary components, addition of specialized devices or circuits, and/or integration of a plurality of devices.

While the exemplary embodiments described above have been chosen primarily from the field of optical communication, one of skill in the art will appreciate that the principles of the invention are equally well applied, and that the benefits of the present invention are equally well realized in a wide variety of other communications systems including, for example, electronic command and control systems. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A price evaluation system comprising:
a computer processor; and
a computer memory device, said computer memory device being operatively coupled to said computer processor, said computer memory device being adapted to include a first plurality of data values encoded in a first electronic state of indefinite duration in a first region of said computer memory device, said first plurality of data values representing a corresponding plurality of operative processing steps; said computer memory device being adapted to include a second plurality of data values encoded in a second electronic state of indefinite duration in a second region of said computer memory device, said second plurality of data values representing competition information; said computer processor being adapted to evaluate said first and second pluralities of data values so as to produce a graphically displayed prediction for a future competitive price of a tangible consumer good.

2. A price evaluation system as defined in claim 1 wherein said plurality of operative processing steps is adapted to perform a time series analysis.

3. A price evaluation system as defined in claim 1 wherein said plurality of operative processing steps is adapted to perform a multi-factor analysis.

4. A price evaluation system as defined in claim 1 wherein said plurality of operative processing steps is adapted to perform a game theory analysis.

5. A price evaluation system as defined in claim 1 wherein said plurality of operative processing steps is adapted to perform a multi-factor analysis.

6. A price evaluation system as defined in claim 1 wherein said plurality of operative processing steps is adapted to perform a econometrics analysis.

7. A price evaluation system as defined in claim 1 wherein said plurality of operative processing steps is adapted to perform a probability and Bayesian theory analysis.

8. A price evaluation system as defined in claim 1 wherein said plurality of operative processing steps is adapted to perform a fuzzy logic analysis.

9. A price evaluation system as defined in claim 1 wherein said plurality of operative processing steps is adapted to perform a neural networks analysis.

10. A price evaluation system as defined in claim 1 wherein said plurality of operative processing steps is adapted to perform an interactive what-if analysis.

11. A price evaluation system as defined in claim 1 wherein said competition information includes pricing information for a competitive product.

12. A price evaluation system as defined in claim 1 wherein said competition information includes pricing information for a defined market basket of competitive products.

13. A price evaluation system as defined in claim 1 wherein said competition information includes pricing information for a plurality of products of a respective plurality of competitors.

14. A price evaluation system as defined in claim 1 wherein said competition information includes revenue information for a competitive product.

15. A price evaluation system as defined in claim 1 wherein said competition information includes demographic information for a geographic area.

16. A price evaluation system as defined in claim 1 wherein said competition information includes transportation facilities information.

17. An automatic computer comprising:
a memory device, said memory device being adapted to store a plurality of competitive retrospective prices of a tangible consumer good, said memory device being adapted to store a control program; and
a processor device, said processor device being operatively coupled to said memory device to receive said plurality of retrospective prices and said control program and to output a report including a projected prospective competitive price for said tangible consumer good.

18. An automatic computer as defined in claim 17 wherein said report further includes a plan-o-gram for a competitor store.

19. An automatic computer as defined in claim 17 wherein said report further includes a plan-o-gram for a user store.

20. A method of distributing a tangible consumer good to a consumer comprising: offering said consumer said tangible consumer good at a first price lower than a corresponding second price of a competitive consumer good, said first price being established by automatically calculating a prospective value of said second price using an electronic computer and setting said first price to be lower than said prospective value.

21. A computer memory device:
said computer memory device being adapted to cooperate with a computer processor, and being adapted to include a first plurality of data values encoded in a first electronic state of indefinite duration in a first region of said computer memory device, said first plurality of data values representing a corresponding plurality of operative processing steps; said computer memory device being adapted to include a second plurality of data values encoded in a second electronic state of indefinite duration in a second region of said computer memory device, said second plurality of data values representing competition information; said cooperation being adapted to evaluate said first and second pluralities of data values so as to result in a graphically displayed prediction for a future competitive price of a tangible consumer good.
